(19) United States
(12) Patent Application Publication
(10) Pub. No.: US 2023/0246788 A1
(43) Pub. Date: Aug. 3, 2023

(54) INFORMATION FEEDBACK METHOD AND APPARATUS

(71) Applicant: FUJITSU LIMITED, Kawasaki-shi (JP)

(72) Inventors: Qinyan JIANG, Beijing (CN); Jian ZHANG, Beijing (CN); Zhe CHEN, Beijing (CN); Lei ZHANG, Beijing (CN)

(73) Assignee: FUJITSU LIMITED, Kawasaki-shi (JP)

(21) Appl. No.: 18/131,544

(22) Filed: Apr. 6, 2023

Related U.S. Application Data
(63) Continuation of application No. PCT/CN2020/121335, filed on Oct. 15, 2020.

(51) Int. Cl. H04L 5/00; H04W 72/1273

(52) U.S. Cl. CPC H04L 5/0055; H04L 5/0048; H04W 72/1273

(57) ABSTRACT

An information feedback apparatus, applicable to a terminal equipment, includes a receiver configured to receive downlink control information (DCI) used for scheduling physical downlink shared channel(s) (PDSCHs), the DCI being used for indicating time-domain resource allocation information of at least two (M) first PDSCHs, and receive at least one (N) second PDSCH, and a transmitter configured to transmit first HARQ-ACK information, the first HARQ-ACK information comprising second HARQ-ACK information of the at least one (N) second PDSCH.

### CROSS-REFERENCE TO RELATED APPLICATION

This application is a continuation application of International Application PCT/CN2020/121335 filed on Oct. 15, 2020 and designated the U.S., the entire contents of which are incorporated herein by reference.

### TECHNICAL FIELD

This disclosure relates to the field of communication technologies.

### BACKGROUND

A physical downlink shared channel (PDSCH) is a type of physical downlink channel in a wireless communication system, which is used to carry downlink data. The PDSCH may be scheduled via downlink control information (DCI). The DCI used to schedule the PDSCH at least includes information indicating resources of the PDSCH. In an existing New Radio (NR) system, a variety of DCI formats for scheduling a PDSCH are defined, such as DCI format 1_ 0, DCI format 1_ 1 and DCI format 1_ 2, and specific information and/or sizes of DCI in different DCI formats is/are different, so as to satisfy different scheduling demands.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY OF THE DISCLOSURE

In an existing NR system, one piece of DCI is only able to schedule one PDSCH. It was found by the inventors that in some cases, for a terminal equipment, such a scheduling mode may have a problem of high monitoring burden of the DCI (PDCCH), resulting in high equipment complexity and power consumption.

For example, how to support an NR system to work at higher frequencies (above 52.6 GHz) is currently under study, and data transmission at higher frequencies faces more serious phase noises and other problems. Therefore, in order to overcome phase noise and other problems, it is possibly needed to adopt larger subcarrier spacings (e.g. 240 kHz, 480 kHz, and 960 kHz) to support data transmission at higher frequencies, while the larger subcarrier spacings mean shorter symbol lengths. If the existing frame structure design of NR is followed (in which one slot includes 14 symbols), a larger subcarrier interval means a shorter slot length. On the other hand, if the above scheduling mode is used to support that a terminal equipment (UE) is able to receive at least one PDSCH at each slot, the UE is needed to monitor DCI at each slot. In this way, when the above larger subcarrier intervals are adopted, the number of times of monitoring the DCI per unit time by the UE increases due to the shorter slot length. In other words, a burden of the UE in monitoring the DCI is increased, and the implementation complexity and power consumption of the UE is also increased accordingly.

Addressed to at least one of the above problems, embodiments of this disclosure provide an information feedback method, an information reception method and apparatuses thereof.

According to an aspect of the embodiments of this disclosure, there is provided an information feedback apparatus, including:
a first receiving unit configured to receive downlink control information (DCI) used for scheduling physical downlink shared channel(s) (PDSCHs), the DCI being used for indicating time-domain resource allocation information of at least two (M) first PDSCHs;
a second receiving unit configured to receive at least one (N) second PDSCH; and
a first transmitting unit configured to transmit first HARQ-ACK information, the first HARQ-ACK information including second HARQ-ACK information of the at least one (N) second PDSCH.

According to another aspect of the embodiments of this disclosure, there is provided an information reception apparatus, including:
a second transmitting unit configured to transmit downlink control information (DCI) used for scheduling physical downlink shared channel(s) (PDSCHs) to a terminal equipment, the DCI being used for indicating time-domain resource allocation information of at least two (M) first PDSCHs;
a third transmitting unit configured to transmit at least one (N) second PDSCH to the terminal equipment; and
a fourth receiving unit configured to receive first HARQ-ACK information transmitted by the terminal equipment, the first HARQ-ACK information including second HARQ-ACK information of the at least one (N) second PDSCH.

According to a further aspect of the embodiments of this disclosure, there is provided a communication system, including at least a terminal equipment and a network device, characterized in that,
the terminal equipment receives downlink control information (DCI) used for scheduling physical downlink shared channel(s) (PDSCHs) transmitted by the network device, the DCI being used for indicating time-domain resource allocation information of at least two (M) first PDSCHs;
the terminal equipment receives at least one (N) second PDSCH transmitted by the network device;
the terminal equipment transmits first HARQ-ACK information to the network device, the first HARQ-ACK information including second HARQ-ACK information of the at least one (N) second PDSCH.

An advantage of the embodiments of this disclosure exists in that multiple PDSCHs may be scheduled by one piece of DCI, and feeding back HARQ-ACK information of multiple PDSCHs scheduled by one piece of DCI is supported in a new HARQ-ACK information feedback method, thereby easing the burden of monitoring the DCI of the terminal equipment, and lowering power consumption and complexity.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/including/includes/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of an embodiment of this disclosure;

FIG. 2 is a schematic diagram of the information feedback method of an embodiment of this disclosure;

FIGS. 3A-3C are schematic diagrams of at least one (N) second PDSCH time-domain position of the embodiment of this disclosure;

FIGS. 4A and 4B are schematic diagrams of the first HARQ-ACK information feedback slot of the embodiment of this disclosure;

FIG. 5 is a schematic diagram of the method for generating a codebook of the embodiment of this disclosure;

FIGS. 6A and 6B are schematic diagrams of the codebook of the embodiment of this disclosure;

FIG. 7 is a schematic diagram of the information reception method of the embodiment of this disclosure;

FIG. 8 is a schematic diagram of the information feedback apparatus of an embodiment of this disclosure;

FIG. 9 is a schematic diagram of the information reception apparatus of an embodiment of this disclosure;

FIG. 10 is a schematic diagram of the network device of an embodiment of this disclosure; and

FIG. 11 is a schematic diagram of the terminal equipment of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, and/or other communication protocols that are currently known or will be developed in the future.

In the embodiments of this disclosure, the term “network device”, for example, refers to a device in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network via the network device and receiving network services. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a handheld device, a machine-type communication device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Moreover, the term “network side” or “network device side” refers to a side of a network, which may be a base station, and may include one or more network devices described above. The term “user side” or “terminal side” or “terminal equipment side” refers to a side of a user or a terminal, which may be a UE, and may include one or more terminal equipments described above. In this text, “a device” may refer to a network device, or may refer to a terminal equipment.

In the embodiment of this disclosure, the time unit may be a subframe, a slot or a set containing at least one time-domain symbol. The set of at least one time-domain symbol may also be referred to as a mini slot or a non-slot. For example, the subframe and slot in the embodiment of this disclosure may be used interchangeably, and “a slot” may also be replaced with “a subframe”, and this disclosure is not limited thereto, and it may also be replaced with other time units. In addition, the terms “a time-frequency resource” and “a resource” may be used interchangeably.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information (e.g. UCI) carried by the PUCCH, transmitting or receiving a PRACH may be understood as transmitting or receiving a preamble carried by the PRACH, transmitting or receiving a PDSCH may be understood as transmitting or receiving downlink information data carried by the PDSCH, and transmitting or receiving a PDCCH may be understood as transmitting or receiving downlink information (e.g. DCI) carried by the PDCCH.

In the embodiment of this disclosure, higher-layer signaling may be, for example, radio resource control (RRC) signaling, such as being referred to as an RRC message, and including a master information block (MIB), system information, and a dedicated RRC message; or being referred to as an RRC information element (RRC IE). The higher-layer signaling may also be, for example, media access control (MAC) signaling, or may be referred to as an MAC control element (MAC CE). However, this disclosure is not limited thereto.

Scenarios of the embodiments of this disclosure shall be described below by way of example; however, this disclosure is not limited thereto.

FIG. 1 is schematic diagram of a communication system of an embodiment of this disclosure, in which a case where terminal equipments and a network device are taken as examples is schematically shown. As shown in FIG. 1, a communication system 100 may include a network device 101 and terminal equipments 102, 103. For the sake of simplicity, an example having only two terminal equipments and one network device is schematically given in FIG. 1; however, the embodiment of this disclosure is not limited thereto.

In the embodiment of this disclosure, existing services or services that may be implemented in the future may be performed between the network device 101 and the terminal equipments 102, 103. For example, such services may include but not limited to an enhanced mobile broadband (eMBB), massive machine type communication (mMTC), ultra-reliable and low-latency communication (URLLC), and related communications of reduced capability terminal equipments.

It should be noted that FIG. 1 shows that the two terminal equipments 102 and 103 are both within the coverage of the network device 101; however, the embodiment of this disclosure is not limited thereto. The two terminal equipments 102 and 103 may not be within the coverage of network device 101, or one terminal equipment 102 may be within the coverage of network device 101, and the other terminal equipment 103 may be outside the coverage of network device 101.

In the embodiment of this disclosure, transport blocks (such as one or two transport blocks) carried by different PDSCHs are different. Therefore, “multiple PDSCHs” or “at least two PDSCHs” in the following refer to different PDSCHs carrying different transport blocks. More specifically, transport blocks carried by different PDSCHs correspond to different HARQ processes, wherein different HARQ processes have different HARQ process identifiers.

In an existing scheme, one piece of DCI is only able to schedule one PDSCH, and is unable to schedule multiple PDSCHs. In the embodiment of this disclosure, one piece of DCI is able to schedule multiple PDSCHs, wherein the PDSCHs carry different transport blocks (in a non-repetition manner), thereby easing the burden of monitoring the DCI of the terminal equipment, and lowering power consumption and complexity.

The description shall be given below with reference to various embodiments.

### Embodiment of a First Aspect

The embodiment of this disclosure provides an information feedback method, which shall be described from a side of a terminal equipment.

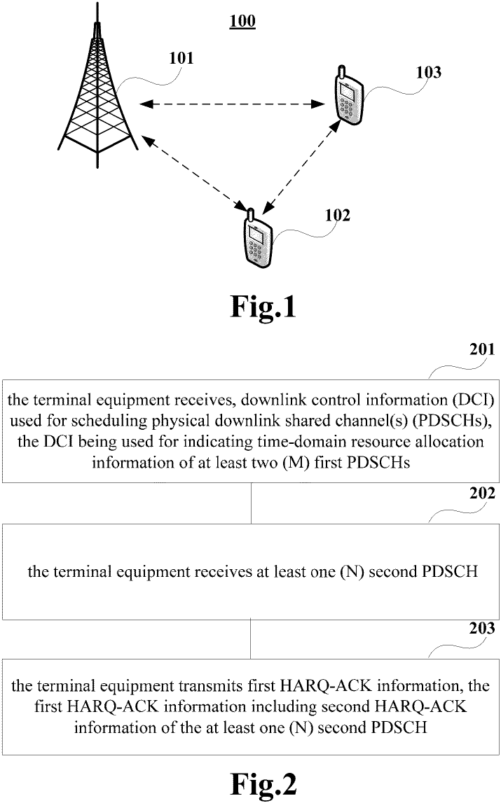

FIG. 2 is a schematic diagram of the information feedback method of the embodiment of this disclosure. As shown in FIG. 2, the method includes:
201: the terminal equipment receives, downlink control information (DCI) used for scheduling physical downlink shared channel(s) (PDSCHs), the DCI being used for indicating time-domain resource allocation information of at least two (M) first PDSCHs;
202: the terminal equipment receives at least one (N) second PDSCH; and
203: the terminal equipment transmits first HARQ-ACK information, the first HARQ-ACK information including second HARQ-ACK information of the at least one (N) second PDSCH.

In some embodiments, one piece of DCI format of the DCI used to schedule the PDSCHs may be DCI format 1_0, DCI format 1_1, DCI format 1_2, or a new DCI format introduced additionally; however, this disclosure is not limited thereto.

In some embodiments, the DCI used for scheduling the PDSCHs may be scrambled by a cell radio network temporary identifier (C-RNTI), a coding and modulation scheme C-RNTI (MCS-C-RNTI), a configured scheduling RNTI (CS-RNTI), a temporary C-RNTI (TC-RNTI), a system information RNTI (SI-RNTI), a random access RNTI (RA-RNTI), an MsgB-RNTI in a random access response, a paging RNTI, (P-RNTI), or a new RNTI introduced additionally; however, this disclosure is not limited thereto.

In some embodiments, the first PDSCH is a PDSCH indicated by the DCI, which may also be referred to as an indicated PDSCH or a nominal PDSCH. Time-domain resources of the at least two (M) first PDSCHs (hereinafter referred to as M first PDSCHs, where, M is greater than or equal to 2) are contiguous or discontiguous, numbers of time-domain symbols of different first PDSCHs are identical or different, and time-domain resources of each first PDSCH are in one slot or not in one slot; however, the embodiment of this disclosure is not limited thereto.

In some embodiments, the network device side may configure a list of time-domain relationship between PDSCHs and PDCCH (or referred to as a first time-domain resource allocation table) via higher-layer signaling. For example, the network device transmits an RRC message, which includes first configuration information, the first configuration information including at least one first information element, wherein one first information element is used to configure the time-domain relationship between PDSCHs and PDCCH. For example, the first configuration information is PDSCH-TimeDomainResourceAllocationList, the first information element is PDSCH-TimeDomainResourceAllocation, and the first configuration information is included in, for example, pdsch-ConfigCommon or pdsch-Config. The first time-domain resource allocation table includes configuration of at least one row of PDSCH time-domain resources, the configuration of the one row of PDSCH time-domain resources corresponding to the above first information element.

In some embodiments, the DCI includes a first information field for indicating time-domain resources of at least two (M) first PDSCHs. The first information field is, for example, a time-domain resource assignment field, and the first information field contains a fifth number (E) of bits. The fifth number may be configured or predefined; however, the embodiment of this disclosure is not limited thereto. A decimal value to which the fifth number of bits correspond is a value of the first information field. The value of the first information field may be used to indicate which first information element in the first configuration information indicated by the DCI. For example, that the value of the first information field is 0 correspondingly indicates a first first information element in the first configuration information, and that the value of the first information field is 1 correspondingly indicates a second first information element in the first configuration information, and so on, which shall not be enumerated herein any further.

How to determine the indicated at least two (M) first PDSCHs (hereinafter referred to as M first PDSCHs, where, M is greater than or equal to 2) according to the first information field and the first configuration information shall be further described below.

In some embodiments, when the first information field is used to indicate the time-domain resources of the at least two (M) first PDSCHs, the value of the first information field corresponds to one first information element, the one first information element being used to configure a time-domain relationship between the M first PDSCHs and the PDCCH carrying the DCI.

In some embodiments, the first information element may include at least one second information element (e.g. PDSCH-Allocation or startSymbolAndLength) used for configuring the time-domain resources of the PDSCHs (or symbols of the PDSCHs, e.g. including a starting symbol and length (SLIV) of the PDSCHs), and numbers of second information elements included in each first information element are identical or different, in other words, the first information element may contain second information elements of a number of at most a first predetermined value (e.g. maxNrofMultiplePDSCHs), the first predetermined value being predefined and greater than 1; the second information element is used for configuring time-domain resources of one PDSCH, the value of the first information field corresponds to one first information element, the one first information element being used to configure the time-domain relationship between the M first PDSCHs and the PDCCH carrying the DCI, that is, the first information element includes at least two (M) second information elements, each of which being used to configure time-domain resources of one first PDSCH.

In the above embodiment, the second information element includes a PDSCH mapping type (mappingType) and starting symbol and length (startSymbolAndLength) configuration, that is, the time-domain resources of each first PDSCH are determined by their respective PDSCH mapping type and starting symbol and length configuration (in the second information element corresponding thereto). For example, the first configuration information may be expressed by using ASN.1 data format as:

PDSCH-TimeDomainResourceAllocationList ::= SEQUENCE (SIZE(1..maxNrofDL-Allocations))
OF PDSCH-TimeDomainResourceAllocation
PDSCH-TimeDomainResourceAllocation ::= SEQUENCE {

| | |
|---|---|
| k0 | INTEGER (0..32) |
| pdschAllocationList | SEQUENCE (SIZE(1..maxNrofMultiplePDSCHs)) |
| OF PDSCH-Allocation, | |
| ... | |
| } | |
| PDSCH-Allocation ::= SEQUENCE { | |
| mappingType | ENUMERATED {typeA, typeB} |
| startSymbolAndLength | INTEGER (0..127) |

...
}

Or, the second information element includes starting symbol and length configuration (startSymbolAndLength), and the first information element includes PDSCH mapping type configuration (mappingType), that is, time-domain resources of the first PDSCHs apply respective starting symbol and length configurations (in the second information element corresponding thereto), but are determined by identical PDSCH mapping type configuration. For example, the first configuration information may be expressed by using ASN.1 data format as:

PDSCH-TimeDomainResourceAllocationList ::= SEQUENCE (SIZE(1..maxNrofDL-Allocations) )
OF PDSCH-TimeDomainResourceAllocation

| | |
|---|---|
| k0 | INTEGER(0..32) |
| mappingType | ENUMERATED {typeA, typeB} |
| pdschAllocationList | SEQUENCE (SIZE(1..maxNrofMultiplePDSCHs)) |
| OF PDSCH-Allocation, | |
| ... | |
| } | |
| PDSCH-Allocation ::= SEQUENCE { | |
| startSymbolAndLength | INTEGER (0..127) |

...

In some embodiments, the first information element may include information for configuring a sixth number (F) (e.g. nrOfPDSCHs), the sixth number denoting the number of first PDSCHs to which the first information element corresponds. In a case where the first information field is used to indicate the time-domain resources of the at least two (M) first PDSCHs, a value of the first information field corresponds to one first information element. The first information element is used for configuring the time-domain relationship between the M first PDSCHs and the PDCCH carrying the DCI, and the sixth number F included in the first information element is M above.

In the above embodiment, the first information element includes information (e.g. k0) for configuring a slot offset (K0) between the PDSCHs and PDCCH. For example, k0 indicates a slot offset between starting time-domain positions of F first PDSCHs and a PDCCH, or a slot offset between a first one of F first PDSCHs and a PDCCH. For example, assuming that the PDCCH used to carrying the DCI is transmitted at a slot n, the starting time-domain positions of the F first PDSCHs are at a slot n+K0, or, in other words, the first one of the F first PDSCHs is transmitted at the slot n+K0. Furthermore, the first information element may include information for configuring a PDSCH mapping type (e.g. mappingType) and/or information for configuring time-domain resources of the PDSCHs (or symbols of the PDSCHs, e.g. including information of starting symbol and length (SLIV) of the PDSCHs) (e.g. startSymbolAndLength). For example, the first configuration information may be expressed by using ASN.1 data format as:

PDSCH-TimeDomainResourceAllocationList ::= SEQUENCE (SIZE(1..maxNrofDL-Allocations))
OF PDSCH-TimeDomainResourceAllocation

| | |
|---|---|
| PDSCH-TimeDomainResourceAllocation ::= | SEQUENCE { |
| k0 | INTEGER (0..32) |
| mappingType | ENUMERATED {typeA, typeB} |
| startSymbolAndLength | INTEGER (0..127) |
| nrOfPDSCHs | INTEGER(1..8) |

where, SEQUENCE denotes an ordered set of corresponding information, SIZE denotes the number of elements in a corresponding SEQUENCE set, INTEGER () and ENUMERATED () denote a value type and value range of corresponding information. Reference may be made to ASN.1 syntax for details, which shall not be described herein any further.

In the above embodiment, time-domain resources of the F first PDSCHs may be determined by using identical PDSCH mapping type and starting symbol and length; or, time-domain resources of the first one of the F first PDSCHs may be determined by using the PDSCH mapping type and starting symbol and length, and time-domain resource length of time-domain resources the remaining (F-1) first PDSCHs are identical to that of the first one of the first PDSCHs and are sequentially mapped on contiguous symbols.

In some embodiments, the first information element may include information (e.g. nrOfSlots) on a seventh number (G), the seventh number denoting the number of slots to which the first information element corresponds. The value of the first information field corresponds to one first information element, the first information element is used to configure the time-domain relationship between the M first PDSCHs and the PDCCH carrying the DCI, and the seventh number G included in the one first information element is M above.

In the above embodiment, the first information element includes information (e.g. k0) for configuring a slot offset (K0) between the PDSCHs and PDCCHs. For example, k0 indicates a slot offset between starting time-domain positions of G first PDSCHs and a PDCCH, or a slot offset between a first one of G first PDSCHs and a PDCCH. For example, assuming that the PDCCH used to carrying the DCI is transmitted at a slot n, the starting time-domain positions of the G first PDSCHs are at a slot n+K0, or, in other words, the first one of the G first PDSCHs is transmitted at the slot n+K0. Furthermore, the first information element may include information for configuring a PDSCH mapping type (e.g. mappingType) and/or information for configuring time-domain resources of the PDSCHs (or symbols of the PDSCHs, e.g. including starting symbol and length (SLIV) of the PDSCHs) (e.g. startSymbolAndLength), and time-domain resources of the G first PDSCHs may be determined by using identical PDSCH mapping type and starting symbol and length.

For example, the first configuration information may be expressed by using ASN.1 data format as:

PDSCH-TimeDomainResourceAllocationList ::= SEQUENCE (SIZE(1..maxNrofDL-Allocations))
OF PDSCH-TimeDomainResourceAllocation

| | |
|---|---|
| PDSCH-TimeDomainResourceAllocation ::= | SEQUENCE { |
| k0 | INTEGER (0..32) |
| mappingType | ENUMERATED {typeA, typeB} |
| startSymbolAndLength | INTEGER (0..127) |
| nrOfSlots | INTEGER (1..8) |

In some embodiments, the network device may further configure a slot offset (K₀) between multiple PDSCHs and PDCCH via higher-layer signaling, that is, the time-domain resources of the M first PDSCHs apply their respective (K0) information to determine their respective slots. For example, information on the slot offset (K₀) between the PDSCHs and the PDCCH may be included in the second information element, and the time-domain resources of the M first PDSCHs apply their respective (K₀) information to determine their respective slots, which shall not be enumerated herein any further.

The above description is given by taking that the network device side configures the list (or PDSCH time-domain resource allocation list) of the time-domain relationship between the PDSCHs and PDCCH via higher-layer signaling as an example; however, the embodiment of this disclosure is not limited thereto. For example, time-domain resources of multiple PDSCHs may also be configured by predefining the list of time-domain relationship between the PDSCHs and PDCCH, and configuration of one row thereof is similar to the configuration of the first information element above, which shall not be repeated herein any further.

How to determine at least one (N) second PDSCH shall be further described below.

In some embodiments, the second PDSCH is an actually-scheduled PDSCH (e.g. a scheduled PDSCH, an actual PDSCH), and the first PDSCH is the second PDSCH, N = M, and N and M are greater than or equal to 2. In other words, an M first PDSCHs indicated by the DCI are an N actually-scheduled second PDSCHs.

In some embodiments, the terminal equipment may determine the at least one (N) second PDSCH according to at least one piece of the following information: a semi-statically configured transmission direction (or, in other words, information for semi-statically configuring a transmission direction), a configured PRACH resource, information for dynamically scheduling uplink transmission or information for dynamically configuring a transmission direction, a configured invalid symbol, and whether it is cross-slot, which shall be described below separately.

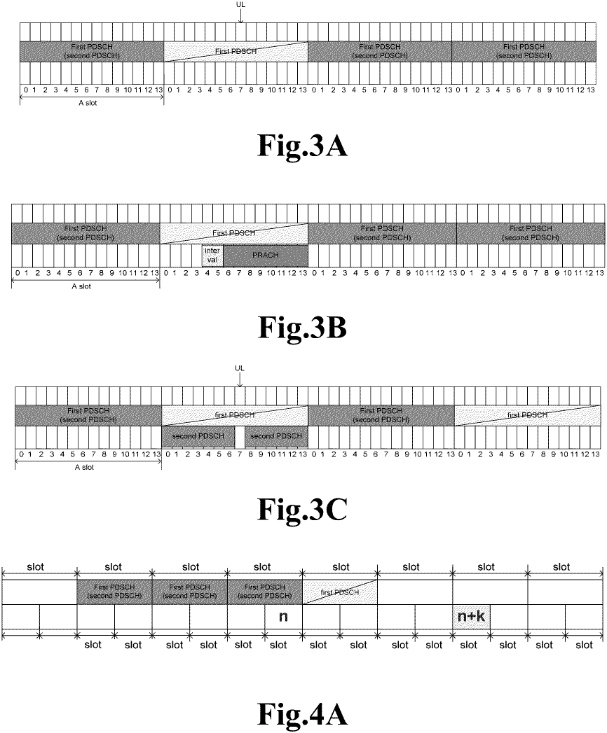

In some embodiments, the semi-statically configuring means that a base station configures via cell-level/user-specific-level higher-layer signaling. The information used for semi-statically configuring the transmission direction is, for example, tdd-UL-DL-ConfigurationCommon or tdd-UL-DL-ConfigurationDedicated, and a transmission direction of a time unit (e.g. a symbol, a slot, a subframe) may be semi-statically configured as being uplink, downlink or flexible, wherein a time unit that is not explicitly configured as being uplink or downlink by the above information is a time unit that is configured as being flexible. When N second PDSCHs are determined according to the semi-statically configured transmission direction, when at least one symbol of the first PDSCH is semi-statically configured as being uplink (that is, it is unable to receive a downlink PDSCH), the first PDSCH is not taken as a second PDSCH, in other words, the terminal equipment does not receive the first PDSCH. For example, for a slot in multiple slots (assuming that there is a first PDSCH at one slot), if at least one symbol of the first PDSCH indicated by the DCI at the slot is semi-statically configured as being uplink, the terminal equipment does not receive the first PDSCH at the slot. FIG. 3A is a schematic diagram of at least one second PDSCH. As shown in FIG. 3A, it is supposed that one symbol of the first PDSCH at a second slot in the figure is semi-statically configured as being uplink and other symbols in the figure are not configured as being uplink, the first PDSCH is not taken as a second PDSCH.

In some embodiments, when N second PDSCHs are determined according to a configured PRACH resource, when at least one symbol of the first PDSCH is configured with a PRACH and/or at least one symbol of the first PDSCH is a symbol in a tenth number (the tenth number is predefined, for example) (such as being referred to as an interval symbol) before the configured PRACH, the first PDSCH is not taken as the second PDSCH. FIG. 3B is a schematic diagram of the at least one second PDSCH. As shown in FIG. 3B, at least one symbol in the first PDSCH in a second slot in the figure is configured with a PRACH and at least one symbol of the first PDSCH is a symbol in the tenth number (the number is predefined, for example) (such as being referred to as an interval symbol) before the configured PRACH, the first PDSCH is not taken as the second PDSCH, in other words, the terminal equipment does not receive the first PDSCH.

In some embodiments, the transmission direction may be configured by the information for dynamically configuring a transmission direction as being uplink, downlink or flexible, wherein a time unit that is not explicitly configured as being uplink or downlink by the above information is a time unit that is configured as being flexible. When the N second PDSCHs are determined according to information for dynamically scheduling uplink transmission or the information for dynamically configuring a transmission direction information, and when at least one symbol in the first PDSCH is dynamically scheduled uplink transmission by the information or a transmission direction is dynamically configured as being uplink by the information, the first PDSCH is not taken as the second PDSCH, in other words, the terminal equipment does not receive the first PDSCH. The above implementations and implementations of the semi-static configuration shall not be described herein any further.

In the above embodiment, the information used for dynamically scheduling uplink transmission (such as DCI of DCI format 0_0 or DCI format 0_1 or DCI format 0_2) or the information used for dynamically configuring a transmission direction (such as DCI of DCI format 2_0) is transmitted before the DCI; otherwise, the UE does not determine the second PDSCH according to the information, or does not consider the information in determining at least one second PDSCH.

Or, in the above embodiment, the information used for dynamically scheduling uplink transmission (such as DCI of DCI format 0_0 or DCI format 0_1 or DCI format 0_2) or the information used for dynamically configuring a transmission direction (such as DCI of DCI format 2_0) is transmitted certain time before the DCI (for example, the certain time is predefined); otherwise, the UE does not determine the second PDSCH according to the information, or does not consider the information in determining at least one second PDSCH.

In some embodiments, when at least one second PDSCH is determined according to the configured invalid symbol, and when at least one symbol of the first PDSCH is configured as being invalid (that is, it is unable to receive a downlink PDSCH), the first PDSCH is not taken as the second PDSCH. The above implementations and implementations of the semi-static configuration shall not be described herein any further.

In some embodiments, the terminal equipment may also determine an invalid symbol according to at least one piece of the following information: a semi-statically configured transmission direction (or information for semi-statically configuring a transmission direction), a configured PRACH resource, information for dynamically scheduling uplink transmission or information for dynamically configuring a transmission direction, and a configured invalid symbol. For example, the above semi-statically configured uplink symbol may be determined as an invalid symbol, and/or the symbol configured with the PRACH resource may be determined as an invalid symbol, and/or a symbol in the tenth number of symbols (the tenth number is predefined, for example) (such as being referred to as an interval symbol) before the PRACH may be determined as an invalid symbol, and/or a symbol of which uplink transmission is dynamically scheduled by the information used for dynamically scheduling uplink transmission may be determined as an invalid symbol, and/or a symbol that is configured by the information for dynamically configuring a transmission direction as being uplink may be determined as an invalid symbol, and/or a symbol configured as being invalid may be determined as an invalid symbol. If the first PDSCH contains a determined invalid symbol, the first PDSCH is not taken as the second PDSCH, and specific implementations are as described above, which shall not be described herein any further.

The above factors for determining at least one (N) second PDSCH or determining invalid symbols may be implemented separately or in a combined manner, and the embodiment of this disclosure is not limited thereto.

In some embodiments, the value of N does not exceed a maximum number of the first PDSCHs corresponding to the above first information elements, or the value of N does not exceed M. FIG. 3C is a schematic diagram of at least one second PDSCH. Assuming that the value of N does not exceed M, as shown in FIG. 3C, the value of M is 4, and the number N of the second PDSCHs is 4 at most, which are illustrative only, and the embodiment of this disclosure is not limited thereto. Other information fields that the DCI may contain shall be further described below.

In some embodiments, the DCI may further include a fifth information field, which may be an HARQ acknowledge (HARQ-ACK) timing indicator (i.e., PDSCH-to-HARQ_feedback timing indicator) field. The fifth information field is used to indicate a feedback timing k of HARQ-ACK information, or the DCI may also exclude the fifth information field, and the terminal equipment receives second configuration information (such as dl-DataToUL-ACK or dl-DataToUL-ACKForDCIFormatl 2 for DCI format 1_2) configured via higher-layer signaling, the second configuration information being used to indicate the feedback timing k of the HARQ-ACK information.

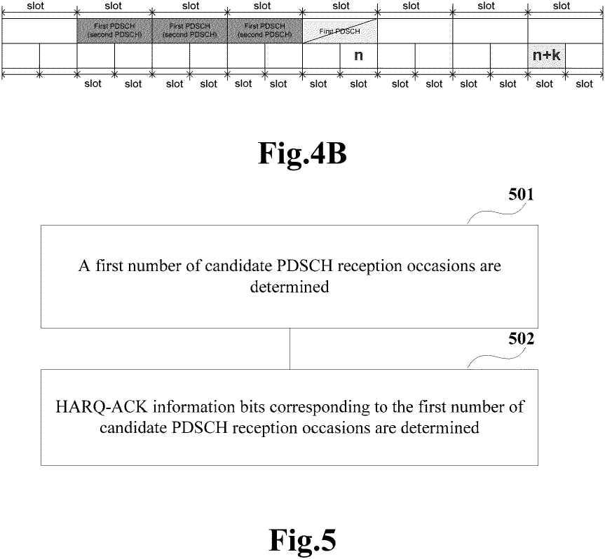

In some embodiments, the terminal equipment transmits the first HARQ-ACK information at a slot (slot n+k) with an index n+k, wherein the slot (slot n) with an index n is an ending slot of the at least two (M) first PDSCHs or an ending slot of a last one of the at least two (M) first PDSCHs, and n and k are integers greater than 0. That is, the ending slot of the last first PDSCH is n (an uplink slot index to which a downlink ending slot n′ of the PDSCH corresponds is n), k is an offset between a feedback slot of the first HARQ-ACK information and the slot n, and a relationship between the downlink ending slot n′ of the PDSCH and the uplink slot with an index n corresponding thereto may be determined according to uplink and downlink subcarrier intervals, and reference may be made to existing techniques for detail, which shall not be described herein any further. FIG. 4A and FIG. 4B are schematic diagrams of the first HARQ-ACK information feedback slot. As shown in FIG. 4A, the M first PDSCHs are N second PDSCHs that are actually scheduled, a downlink ending of the last first PDSCH is n, and the slot n+k transmits the first HARQ-ACK information. As shown in FIG. 4B, the last first PDSCH is not taken as a second PDSCH, a downlink ending of the last first PDSCH is n, and the slot n+k transmits the first HARQ-ACK information, rather than taking the downlink ending of the last first PDSCH as n.

In some embodiments, the first HARQ-ACK information is carried by a PUCCH or a PUSCH, and second HARQ-ACK information of the at least one (N) second PDSCH is carried by the same PUCCH or PUSCH.

In some embodiments, the whole HARQ-ACK information fed back by the terminal equipment on a physical uplink resource may be referred to as an HARQ-ACK codebook. The terminal equipment transmits the first HARQ-ACK information by using a semi-static HARQ-ACK codebook, or, in other words, the first HARQ-ACK information is a semi-static HARQ-ACK codebook, which is also referred to as a Type-1 HARQ-ACK codebook. A size of the codebook does not change dynamically with actual data scheduling, but is determined according to preconfigured (e.g. being configured by higher-layer signaling) or predefined parameters.

How to generate the first HARQ-ACK information (that is, how to generate the codebook) shall be further described below.

In some embodiments, the codebook may include HARQ-ACK information bits of one or more serving cells. How to determine HARQ-ACK information bits of a serving cell shall be only described below. In a case where the codebook includes HARQ-ACK information bits of multiple serving cells, methods for determining the HARQ-ACK information bits of the serving cells are identical to the method for determining the HARQ-ACK information bits of one serving cell described above.

In some embodiments, the codebook includes HARQ-ACK information bits to which a first number (A) of candidate PDSCH reception occasions correspond, the first number being a natural number. The first number (A) of candidate PDSCH reception occasions correspond to the same serving cell (i.e., the above-described one serving cell), that is, the first number (A) of candidate PDSCH reception occasions belong to a set M_{A,C} of candidate PDSCH reception occasions of the serving cell.

In the existing techniques, as it is only supported that one piece of DCI schedules one PDSCH, the current HARQ-ACK information feedback method does not take a case into account that one piece of DCI schedules multiple PDSCHs, and does not support feeding back HARQ-ACK information of multiple PDSCHs scheduled by one piece of DCI. In the embodiment of this disclosure, one piece of DCI may schedule multiple PDSCHs. In order to support feeding back HARQ-ACK information of multiple PDSCHs scheduled by one piece of DCI, an HARQ-ACK information feedback method is provided, wherein second HARQ-ACK information of the at least one (N) second PDSCH may correspond to the same candidate PDSCH reception occasion or different candidate PDSCH reception occasions, which shall be described below separately.

I. The second HARQ-ACK information of the at least one (N) second PDSCH may correspond to the same candidate PDSCH reception occasion

FIG. 5 is a schematic diagram of the method for generating a codebook. As shown in FIG. 5, the method includes:
501: a first number of candidate PDSCH reception occasions are determined;
502: HARQ-ACK information bits corresponding to the first number of candidate PDSCH reception occasions are determined.

In some embodiments, when a row (that is, a first information element) of the first time-domain resource allocation table corresponds to the fourth number (D) of PDSCH time-domain resources (such as including multiple second information elements or including information of the sixth number or seventh number), the candidate PDSCH reception occasion is determined according to one PDSCH time-domain resource in the fourth number of PDSCHs. For example, the one PDSCH may be a last one in the fourth number of PDSCHs; however, this disclosure is not limited thereto, and the fourth number is greater than 1.

In some embodiments, when a row (that is, a first information element) of the first time-domain resource allocation table corresponds to the fourth number (D) of PDSCH time-domain resources (such as including multiple second information elements or including information of the sixth number or seventh number), the candidate PDSCH reception occasion is determined according to at least two (P) PDSCH time-domain resources in the fourth number of PDSCHs. For example, the at least two (P) PDSCHs may be the fourth number of PDSCHs, i.e., P = D; however, this disclosure is not limited thereto, and the fourth number is greater than 1.

How to determine the candidate PDSCH reception occasion in the above two embodiments shall be described below in detail.

In some embodiments, for an HARQ-ACK information feedback slot nᵤ, according to a set of slot timing values Ki associated with an active uplink bandwidth part UL BWP, downlink slots no corresponding to Ki in the set of K₁ may be determined respectively; where, Ki denotes an offset of the PDSCH relative to the HARQ-ACK information feedback slot nᵤ. Reference may be made to existing techniques for determination of the set of K₁. In determining the downlink slots to which Ki corresponds, optionally, it is also needed to take subcarrier spacings of uplink and downlink bandwidth parts into account. One K₁ may possibly correspond to multiple downlink slots. Reference may be made to existing techniques for details, and the embodiment of this disclosure is not limited thereto.

In some embodiments, the terminal equipment determines a first number of candidate PDSCH reception occasions according to a second time-domain resource allocation table. For a downlink slot to which one Ki corresponds, if all rows of the second time-domain resource allocation table satisfy a first condition, the downlink slot has no corresponding candidate PDSCH reception occasion. If at least one row of the second time-domain resource allocation table does not satisfy the first condition, the downlink slot has a corresponding candidate PDSCH reception occasion, or for a downlink slot to which one K₁ corresponds, if all rows of the second time-domain resource allocation table do not satisfy the second condition, the downlink slot has no corresponding candidate PDSCH reception occasion. If at least one row of the second time-domain resource allocation table satisfies a second condition, the downlink slot has a corresponding candidate PDSCH reception occasion; for example, the first condition may be at least one of the following cases where: corresponding one or at least two fifth PDSCH time-domain resources include symbols semi-statically configured as being uplink, corresponding one or at least two fifth PDSCH time-domain resources include symbols configured with PRACHs, corresponding one or at least two fifth PDSCH time-domain resources include symbols configured as being invalid, are unable to be used for scheduling a PDSCH to which the downlink slot corresponds; and the second condition may be at least one of the following cases where: corresponding one or at least two fifth PDSCH time-domain resources do not include symbols semi-statically configured as being uplink, corresponding one or at least two fifth PDSCH time-domain resources do not include symbols configured with PRACHs, corresponding one or at least two fifth PDSCH time-domain resources do not include symbols configured as being invalid, are able to be used for scheduling a PDSCH to which the downlink slot corresponds. For each downlink slots to which each Ki corresponds, whether each downlink slot has corresponding candidate PDSCH reception occasions is determined according to the above method, so as to determine the first number of candidate PDSCH reception occasions, wherein the second time-domain resource allocation table R is used to determine the first number of candidate PDSCH reception occasions, and the second time-domain resource allocation table R is determined according to the first time-domain resource allocation table; for example, the second time-domain resource allocation table includes all or a part of configurations of the first time-domain resource allocation table, which shall be illustrated later in detail.

For example, the second time-domain resource allocation table includes all the configurations of the first time-domain resource allocation table, a row of the second time-domain resource allocation table corresponds to a row of the first time-domain resource table (i.e., a first information element), and when a row of the first time-domain resource allocation table corresponds to a fourth number (D) of PDSCH time-domain resources (such as including multiple second information elements or including information of the sixth number or seventh number), a row of the second time-domain resource allocation table also corresponds to the fourth number of PDSCH time-domain resources.

For the case of “determining the candidate PDSCH reception occasion according to one PDSCH time-domain resource in the fourth number of PDSCHs”:
one PDSCH time-domain resource in the fourth number of PDSCH time-domain resources is taken as a fifth PDSCH time-domain resource, and the candidate PDSCH reception occasion is determined according to the fifth PDSCH time-domain resource; for example, whether the fifth PDSCH time-domain resource includes a symbol semi-statically configured as being uplink or includes a symbol configured with a PRACH or includes a symbol configured as being invalid or unable to be used for scheduling a PDSCH to which the downlink slot corresponds is judged, if yes, the row to which the fifth PDSCH corresponds satisfies the first condition, and if no, the row to which the fifth PDSCH corresponds satisfies the second condition; for example, a last PDSCH time-domain resource in the fourth number of PDSCH time-domain resources may be taken as the fifth PDSCH time-domain resource;
for the case of “determining the candidate PDSCH reception occasion according to at least two PDSCH time-domain resources in the fourth number of PDSCHs”:
at least two (P) PDSCH time-domain resources in the fourth number of PDSCHs are taken as P fifth PDSCH time-domain resources, and the candidate PDSCH reception occasion is determined according to the P fifth PDSCH time-domain resources; for example, whether any one of the P fifth PDSCH time-domain resources includes a symbol semi-statically configured as being uplink or includes a symbol configured with a PRACH or includes a symbol configured as being invalid or whether a PDSCH time-domain resource unable to be scheduled to which the downlink slot corresponds satisfies the first condition or the second condition is judged, if yes, the row to which the P fifth PDSCHs correspond satisfies the first condition, and if no, the row to which the P fifth PDSCHs correspond satisfies the second condition; for example, the fourth number of PDSCH time-domain resources may be taken as the P fifth PDSCH time-domain resources; however, this embodiment is not limited thereto.

Or, for example, at least two (P) PDSCH time-domain resources in the fourth number of PDSCH time-domain resources are taken as the P fifth PDSCH time-domain resources, and the candidate PDSCH reception occasion is determined according to the P fifth PDSCH time-domain resources. For example, whether each fifth PDSCH in the P fifth PDSCH time-domain resources includes a symbol semi-statically configured as being uplink or includes a symbol configured with a PRACH or includes a symbol configured as being invalid or whether a PDSCH time-domain resource unable to be scheduled to which the downlink slot corresponds satisfies the first condition or the second condition is judged, if yes, the row to which the P fifth PDSCHs correspond satisfies the first condition, and if no, the row to which the P fifth PDSCHs correspond satisfies the second condition; for example, the fourth number of PDSCH time-domain resources may all be taken as the P fifth PDSCH time-domain resources; however, this embodiment is not limited thereto.

For example, the second time-domain resource allocation table includes a part of the configurations of the first time-domain resource allocation table, and a row of the second time-domain resource allocation table corresponds to a row of the first time-domain resource table (i.e., a first information element). When a row of the first time-domain resource allocation table corresponds to a fourth number (D) of PDSCH time-domain resources (such as including multiple second information elements or information of the sixth number or seventh number), a row of the second time-domain resource allocation table corresponds to one PDSCH time-domain resource, the one PDSCH time-domain resource being a PDSCH time-domain resource in the fourth number of PDSCH time-domain resources. For example, a last PDSCH time-domain resource in the fourth number of PDSCH time-domain resources may be taken as the one PDSCH time-domain resource.

For the case of “determining the candidate PDSCH reception occasion according to one PDSCH time-domain resource in the fourth number of PDSCHs”:

the one PDSCH time-domain resource is taken as one fifth PDSCH time-domain resource, and the candidate PDSCH reception occasion is determined according to the one fifth PDSCH time-domain resource; for example, whether the fifth PDSCH time-domain resource includes a symbol semi-statically configured as being uplink or includes a symbol configured with a PRACH or includes a symbol configured as being invalid or whether a PDSCH time-domain resource unable to be scheduled to which the downlink slot corresponds satisfies the first condition or the second condition is judged, if yes, the row to which the fifth PDSCH corresponds satisfies the first condition, and if no, the row to which the fifth PDSCH corresponds satisfies the second condition.

For example, the second time-domain resource allocation table includes a part of the configurations of the first time-domain resource allocation table, and one row of the second time-domain resource allocation table corresponds to one row of the first time-domain resource table (i.e., one first information element). When one row of the first time-domain resource allocation table corresponds to a fourth number (D) of PDSCH time-domain resources (such as including multiple second information elements or information of the sixth number or seventh number), one row of the second time-domain resource allocation table corresponds to at least two (P) fifth PDSCH time-domain resources.

For the case of “determining the reception occasion of the candidate PDSCH according to at least two PDSCH time-domain resources in the fourth PDSCH”:

the at least two (P) fifth PDSCH time-domain resources are P PDSCH time-domain resources (P is less than D) in the fourth number of PDSCH time-domain resources, and the candidate PDSCH reception occasion is determined according to the at least two fifth PDSCH time-domain resources. For example, whether each of the at least two fifth PDSCH time-domain resources includes a symbol semi-statically configured as being uplink or includes a symbol configured with a PRACH or includes a symbol configured as being invalid or whether a PDSCH time-domain resource unable to be scheduled to which the downlink slot corresponds satisfies the first condition or the second condition is judged, if yes, the row to which the P fifth PDSCHs correspond satisfies the first condition, and if no, the row to which the P fifth PDSCHs correspond satisfies the second condition; or, whether at least one of the at least two fifth PDSCH time-domain resources includes a symbol semi-statically configured as being uplink or includes a symbol configured with a PRACH or includes a symbol configured as being invalid or whether a PDSCH time-domain resource unable to be scheduled to which the downlink slot corresponds satisfies the first condition or the second condition is judged, if yes, the row to which the P fifth PDSCHs correspond satisfies the first condition, and if no, the row to which the P fifth PDSCHs correspond satisfies the second condition.

In some embodiments, in determining the first number of candidate PDSCH reception occasions, a BWP handover timing may also be taken into account. For example, if a downlink slot is before the BWP handover and a corresponding uplink slot (i.e., an uplink slot where the UE transmits the first HARQ-ACK information) is after the BWP handover, the downlink slot has no corresponding candidate PDSCH reception occasions. In addition, other factors may also be taken into account in determining the first number of candidate PDSCH reception occasions, such as a UE capability, and reference may be made to existing techniques for details thereof, which shall not be enumerated herein any further.

How to determine the first number of candidate PDSCH reception occasions is described in the above embodiment, and in 502, the HARQ-ACK information bits corresponding to the first number of candidate PDSCH reception occasions are determined. In some embodiments, the number of the HARQ-ACK information bits to which the candidate PDSCH reception occasion corresponds is correlated with a second number (B) to which the candidate PDSCH reception occasion corresponds and/or an HARQ-ACK bundling relationship between PDSCHs, that is, the terminal equipment may determine the number of HARQ-ACK information bits to which a candidate PDSCH reception occasion corresponds according to the second number and the bundling relationship.

In some embodiments, the second number may be the number of fourth PDSCHs (candidate PDSCHs) to which the candidate PDSCH reception occasion corresponds. In other words, the fourth PDSCHs (or candidate PDSCHs) in the embodiment of this disclosure are used to determine the HARQ-ACK information bits to which the candidate PDSCH reception occasion corresponds, which refers to, for example, the number of PDSCHs that may (or possibly may/can) be scheduled by one piece of DCI, but is not equivalent to the number of PDSCHs (second PDSCHs) actually scheduled by the DCI or the number of PDSCHs (first PDSCHs) actually indicated by the DCI. The correlation between the number of HARQ-ACK information bits to which one candidate PDSCH reception occasion corresponds and the second number B to which the one candidate PDSCH reception occasion corresponds refers to that a value of the second number has an effect on the value of the number of HARQ-ACK information bits to which the candidate PDSCH reception occasion corresponds. For example, it is supposed that the number of HARQ-ACK information bits to which the one candidate PDSCH reception occasion corresponds is

$${N}_{c , m}^{\text{HARQ} - \text{ACK}} = {N}_{\text{HARQ} - \text{ACK,} c}^{\text{PDSCH}} ∗ {N}_{c , m}^{\text{PDSCH}} ;$$

where,

$${N}_{\text{HARQ} - \text{ACK,} c}^{\text{PDSCH}}$$

denotes the number of HARQ-ACK information bits to which one PDSCH corresponds, and that the number of HARQ-ACK information bits to which one candidate PDSCH reception occasion corresponds is correlated with the second number B refers to that

$${N}_{c , m}^{\text{PDSCH}}$$

is equal to the second number.

For example, the second number is a maximum number in the numbers of PDSCHs to which rows in the second time-domain resource allocation table or the first time-domain resource allocation table correspond. When the first information element includes at least two second information elements, for example, when a row of the first time-domain resource allocation table or the second time-domain resource allocation table corresponds to at least two PDSCH time-domain resources, the second number is a maximum number in the numbers of PDSCH time-domain resources to which the rows correspond, and when the first information element includes information of the sixth number or seventh number, for example, when a row of the first time-domain resource allocation table or the second time-domain resource allocation table is correspondingly information configured with the sixth (or seventh) number, the second number is a maximum number in sixth (or seventh) numbers to which the rows correspond. The numbers of HARQ-ACK information bits to which the candidate PDSCH reception occasions correspond are identical.

Or, for example, the second number is a maximum number in the numbers of PDSCHs to which rows in the second time-domain resource allocation table satisfying the second condition correspond. When the first information element includes at least two second information elements, for example, when a row of the first time-domain resource allocation table or the second time-domain resource allocation table corresponds to at least two PDSCH time-domain resources, the second number is a maximum number in the numbers of PDSCH time-domain resources to which the rows satisfying the second condition correspond, and when the first information element includes information of the sixth or seventh number, for example, when a row of the first time-domain resource allocation table or the second time-domain resource allocation table is correspondingly configured with information of the sixth (or seventh) number, the second number is a maximum number in sixth (or seventh) numbers to which the rows satisfying the second condition correspond. The numbers of HARQ-ACK information bits to which the candidate PDSCH reception occasions correspond are identical or different. And implementation of whether a row satisfies the second condition is as described above, which shall not be described herein any further.

Or, for example, the second number is a maximum number in the numbers of PDSCHs to which rows in the second time-domain resource allocation table satisfying the second condition correspond other than PDSCHs including a symbol semi-statically configured as being uplink or including a symbol configured with a PRACH or including a symbol configured as being invalid. When the first information element includes at least two second information elements, for example, when a row of the first time-domain resource allocation table or the second time-domain resource allocation table corresponds to at least two PDSCH time-domain resources, the second number is a maximum number in the numbers of PDSCH time-domain resources to which rows of PDSCHs satisfying the second condition other than the PDSCHs including a symbol semi-statically configured as being uplink or including a symbol configured with a PRACH or including a symbol configured as being invalid correspond, and when the first information element includes information of the sixth or seventh number, for example, when a row of the first time-domain resource allocation table or the second time-domain resource allocation table is correspondingly configured with the information of sixth (or seventh) number, the second number is a maximum number in eighth numbers to which the rows of the PDSCHs satisfying the second condition correspond, the eighth number being the sixth (or seventh) number subtracted by the number of the PDSCHs including a symbol semi-statically configured as being uplink or including a symbol configured with a PRACH or including a symbol configured as being invalid. The numbers of HARQ-ACK information bits to which the candidate PDSCH reception occasions correspond are identical or different. And implementation of determining whether a row satisfies the second condition is as described above, which shall not be described herein any further.

In some embodiments, the correlation between the number of HARQ-ACK information bits to which a candidate PDSCH reception occasion corresponds and the HARQ-ACK bundling relationship between the PDSCHs refers to that when there is an HARQ-ACK bundling relationship between at least two fourth PDSCHs in the fourth PDSCHs (candidate PDSCHs) to which the candidate PDSCH reception occasion corresponds, HARQ-ACK information bits of the at least two fourth PDSCHs with the bundling relationship are jointly encoded. The joint encoding may be logical AND operation performed on HARQ-ACK information bits to which the PDSCHs with the HARQ-ACK bundling relationship correspond.

In the above embodiment, when the above bundling relationship exists, the number of the HARQ-ACK information bits to which the candidate PDSCH reception occasion corresponds is reduced due to the joint encoding.

In some embodiments, the method may further include (optional, not shown): the terminal equipment receives, configuration information used for configuring the HARQ-ACK bundling relationship between PDSCHs, the configuration information harq-ACK-PDSCHBundlingPUCCH being able to be carried by RRC signaling. For example, when the configuration information configures that there is an HARQ-ACK bundling relationship between multiple PDSCHs (fourth PDSCHs to which a candidate PDSCH reception occasion corresponds) that may be scheduled by one piece of DCI, the number of HARQ-ACK information bits to which the candidate PDSCH reception occasion corresponds is equal to the number

$${N}_{\text{HARQ} - \text{ACK,} c}^{\text{PDSCH}}$$

of HARQ-ACK information bits to which a PDSCH corresponds.

For example, as shown in Table 1 below, there exists an HARQ-ACK bundling relationship between two fourth PDSCHs (PDSCH1 and PDSCH2) to which a candidate PDSCH reception occasion corresponds, and HARQ-ACK information to which the candidate PDSCH reception occasion corresponds is information after the joint encoding.

TABLE 1

| | | |
|---|---|---|
| HARQ-ACK information to which PDSCH1 corresponds | HARQ-ACK information to which PDSCH2 corresponds | Joint encoding |
| ACK (1) | ACK (1) | ACK(1) |
| NACK (0) | ACK (1) | NACK (0) |
| ACK (1) | NACK (0) | NACK (0) |
| NACK (0) | NACK (0) | NACK (0) |

In some embodiments, the number

$${N}_{\text{HARQ} - \text{ACK,} c}^{\text{PDSCH}}$$

of HARQ-ACK information bits to which a PDSCH corresponds may be determined according to a spatial bundling parameter, the coding block group (CBG) configuration parameter and a supported maximum codeword parameter, and may be of, for example, 1 bit or 2 bits, and reference may be made to existing techniques for details, which shall not be repeated herein any further.

In some embodiments, the second numbers to which at least two candidate PDSCH reception occasions in the first number (A) of candidate PDSCH reception occasions correspond are identical or different; however, this embodiment is not limited thereto.

In some embodiments, how to determine the number of HARQ-ACK information bits to which a candidate PDSCH reception occasion corresponds is described above, and modes for determining the number of HARQ-ACK information bits to which candidate PDSCH reception occasions in the first number (A) of candidate PDSCH reception occasions correspond are similar (wherein modes for determining the second number may possibly be different), which shall not be described herein any further.

In existing techniques, the HARQ-ACK information of one PDSCH corresponds to one candidate PDSCH reception occasion of the codebook, hence, the HARQ-ACK information to which the candidate PDSCH reception occasion corresponds is the HARQ-ACK information of the one PDSCH. In the embodiment of this disclosure, as one candidate PDSCH reception occasion may correspond to multiple fourth PDSCHs, for example, second HARQ-ACK information of at least one (N) second PDSCH may correspond to the same candidate PDSCH reception occasion, after determining the number of HARQ-ACK information bits to which a candidate PDSCH reception occasion corresponds, it is further needed to determine how to arrange the HARQ-ACK information bits to which the candidate PDSCH reception occasion corresponds. And HARQ-ACK information bits to which candidate PDSCH reception occasions in the first number (A) of candidate PDSCH reception occasions correspond are sequentially determined in the same mode, and the HARQ-ACK information bits to which the candidate PDSCH reception occasions in the first number (A) of candidate PDSCH reception occasions correspond are arranged in a time-domain order to which the candidate PDSCH reception occasions correspond or according to indices of the candidate PDSCH reception occasions, so as to obtain HARQ-ACK information bits of a serving cell, and the HARQ-ACK information bits of a serving cell may be fed back as a codebook.

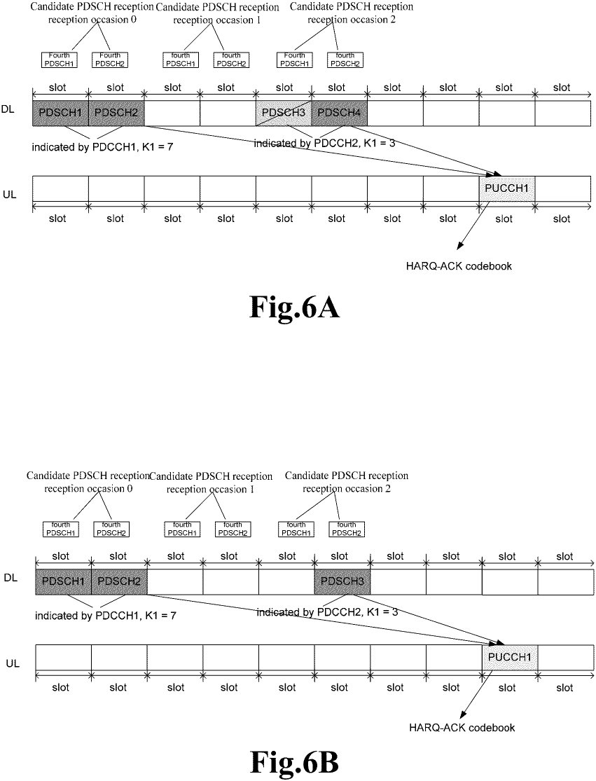

In some embodiments, the HARQ-ACK information bits to which the candidate PDSCH reception occasion corresponds may be arranged in an order of the fourth PDSCHs to which the candidate PDSCH reception occasion corresponds, that is, in a time-domain order or indices of the fourth PDSCHs to which the candidate PDSCH reception occasion corresponds; for example, the HARQ-ACK information bits to which the fourth PDSCHs correspond are sequentially arranged in the order of the fourth PDSCHs starting from a low bit (LSB) of the HARQ-ACK information bits to which the candidate PDSCH reception occasion corresponds, and remaining HARQ information bits to which the candidate PDSCH reception occasion corresponds are set to be NACK, wherein for fourth PDSCHs without corresponding second PDSCHs (i.e., candidate PDSCHs without corresponding actually scheduled PDSCHs), their corresponding HARQ-ACK information bits are set to be NACK. FIG. 6A and FIG. 6B are schematic diagrams of arrangement of the information bits of the candidate PDSCH reception occasions. As shown in FIG. 6A, two fourth PDSCHs (i.e., the number of PDSCHs that may be scheduled by one piece of DCI) to which each of candidate PDSCH reception occasions 0, 1, 2 corresponds are identical, and are 2, wherein both the two fourth PDSCHs of the candidate PDSCH reception occasion 0 have corresponding second PDSCHs (i.e., PDSCH1 and PDSCH2), the two fourth PDSCHs of the candidate PDSCH reception occasion 1 have no corresponding second PDSCHs, and the two fourth PDSCHs of the candidate PDSCH reception occasion 2 have a corresponding first PDSCH (i.e., PDSCH3) and a corresponding second PDSCH (i.e., PDSCH4). Assuming that HARQ-ACK information to which a fourth PDSCH corresponds is of 1 bit, the codebook is {PDSCH1-HARQ, PDSCH2-HARQ, NACK, NACK, NACK, PDSCH4-HARQ}; where, PDSCH1-HARQ denotes the HARQ-ACK information (NACK or ACK) to which PDSCH1 corresponds, and so on. As shown in FIG. 6B, two fourth PDSCHs (i.e., the number of PDSCHs that may be scheduled by one piece of DCI) to which each of candidate PDSCH reception occasions 0, 1, 2 corresponds are identical, and are 2, wherein both the two fourth PDSCHs of the candidate PDSCH reception occasion 0 have corresponding second PDSCHs (i.e., PDSCH1 and PDSCH2), the two fourth PDSCHs of the candidate PDSCH reception occasion 1 have no corresponding second PDSCHs, and the two fourth PDSCHs of the candidate PDSCH reception occasion 2 have a corresponding second PDSCH (i.e., PDSCH3). Assuming that HARQ-ACK information to which a fourth PDSCH corresponds is of 1 bit, the codebook is {PDSCH1-HARQ, PDSCH2-HARQ, NACK, NACK, NACK, PDSCH3-HARQ}, wherein when a value of the 1 bit is 0, it indicates NACK, and when a value of the 1 bit is 1, it indicates ACK.

In some embodiments, the HARQ-ACK information bits to which the candidate PDSCH reception occasion corresponds may be arranged in the order of the second PDSCHs to which the candidate PDSCH reception occasion corresponds, that is, in the time-domain order or indices of the second PDSCH to which the candidate PDSCH reception occasion corresponds; for example, the HARQ-ACK information bits to which the second PDSCHs correspond are sequentially arranged in the order of the second PDSCHs starting from a low bit (LSB) of the HARQ-ACK information bits to which the candidate PDSCH reception occasion corresponds, and remaining HARQ information bits to which the candidate PDSCH reception occasion corresponds are set to be NACK. For example, as to FIG. 6A, assuming that HARQ-ACK information to which a fourth PDSCH corresponds is of 1 bit, the codebook is {PDSCH1-HARQ, PDSCH2-HARQ, NACK, NACK, NACK, PDSCH4-HARQ}; and as shown in FIG. 6B, assuming that HARQ-ACK information to which a fourth PDSCH corresponds is of 1 bit, the codebook is {PDSCH1-HARQ, PDSCH2-HARQ, NACK, NACK, PDSCH3-HARQ, NACK}, wherein when a value of the 1 bit is 0, it indicates NACK, and when a value of the 1 bit is 1, it indicates ACK.

In some embodiments, the HARQ-ACK information bits to which the candidate PDSCH reception occasion corresponds may be sequentially arranged in an order of the first PDSCHs to which the candidate PDSCH reception occasion corresponds, that is, in a time-domain order or indices of the first PDSCHs to which the candidate PDSCH reception occasion corresponds; for example, the HARQ-ACK information bits to which the first PDSCHs correspond are sequentially arranged in the order of the first PDSCHs starting from a low bit (LSB) of the HARQ-ACK information bits to which the candidate PDSCH reception occasion corresponds, and remaining HARQ information bits to which the candidate PDSCH reception occasion corresponds are set to be NACK, wherein for a first PDSCH that is not a second PDSCH, HARQ information bits to which the first PDSCH corresponds are set to be NACK. For example, as to FIG. 6A, assuming that HARQ-ACK information to which a fourth PDSCH corresponds is of 1 bit, the codebook is {PDSCH1-HARQ, PDSCH2-HARQ, NACK, NACK, NACK, PDSCH4-HARQ}; and as shown in FIG. 6B, assuming that HARQ-ACK information to which a fourth PDSCH corresponds is of 1 bit, the codebook is {PDSCH1-HARQ, PDSCH2-HARQ, NACK, NACK, PDSCH3-HARQ, NACK}, wherein when a value of the 1 bit is 0, it indicates NACK, and when a value of the 1 bit is 1, it indicates ACK.

In some embodiments, as described above, in the case where the codebook includes the HARQ-ACK information bits of one serving cell, the HARQ-ACK information bits of the one serving cell are fed back as a codebook, and in the case where the codebook includes the HARQ-ACK information bits of multiple serving cells, the modes for determining the HARQ-ACK information bits of each serving cell are identical to the mode for determining the HARQ-ACK information bits of the previous one serving cell. However, in specific determination, other parameters, such as the first time-domain resource allocation table and/or the second time-domain resource allocation table and the set of K1 to which each serving cell correspond may be identical or different; for example, the above parameters may possibly be configured separately for each serving cell; however, this embodiment is not limited thereto. The HARQ-ACK information bits to which each serving cell correspond may be sequentially arranged in an ascending order of indices of the serving cells, so as to generate a codebook for feedback.

II. The second HARQ-ACK information of at least one (N) second PDSCH may correspond to different candidate PDSCH reception occasions (that is, the second HARQ-ACK information of the N second PDSCHs is fed back at HARQ-ACK information bits to which different candidate PDSCH reception occasions correspond)

In some embodiments, the downlink slots corresponding to each K1 in the set of K1 are determined in the same way as in I, and whether the downlink slots have corresponding candidate PDSCH reception occasions is determined. For example, the candidate PDSCH reception occasions are determined according to one or at least two fifth PDSCHs in the fourth number of PDSCHs described above. Specific implementations are as described above, and shall not be repeated herein any further.

What is different from I is that one candidate PDSCH reception occasion corresponds to one fourth PDSCH, rather than multiple fourth PDSCHs. In order to support feeding back HARQ-ACK information of multiple PDSCHs scheduled by one piece of DCI, the number of candidate PDSCH reception occasions to which one downlink slot corresponds is a third number for the above downlink slots having corresponding candidate PDSCH reception occasions. At least two candidate PDSCH reception occasions in the third number of candidate PDSCH reception occasions corresponding to at least one of the downlink slots in the downlink slots having corresponding candidate PDSCH reception occasions correspond to different slots (or in other words, are at different slots).

In some embodiments, the third number is greater than 1, and/or, the third number is related to a ninth number (I) to which a downlink timing unit corresponds and/or the HARQ-ACK bundling relationship between the PDSCHs, wherein reference may be made to the mode for determining the second number B for a mode for determining the ninth number I, and a mode for configuring the bundling relationship is as described in I, which shall not be repeated herein any further. That the third number is greater than 1 refers to that at least one downlink slot in the downlink slots having corresponding candidate PDSCH reception occasions corresponds to more than one candidate PDSCH reception occasions.

In some embodiments, that the third number is correlated to the ninth number refers to that the third number is greater than or equal to the ninth number. For example, whether the third number is equal to the ninth number or greater than the ninth number is determined according to a UE capability, when the UE does not support receiving more than one PDSCHs in one downlink slot, the third number is equal to the ninth number, and when the UE supports receiving more than one PDSCHs in one downlink slot, the third number is greater than the ninth number.

In some embodiments, that the third number is correlated to the HARQ-ACK bundling relationship between PDSCHs refers to that the third number may be reduced when there exists an HARQ-ACK bundling relationship between fourth PDSCHs corresponding to a candidate PDSCH reception occasion corresponding to one downlink slot, for example, the third number may be less than the ninth number. For example, when the UE does not support receiving more than one PDSCHs in one downlink slot, the third number is equal to 1 when RRC signaling configures that there exists a bundling relationship, and when the UE does not support receiving more than one PDSCHs in one downlink slot, when it is not configured with a bundling relationship by RRC signaling, the third number is equal to the number of rows in the second time-domain resource allocation table having no overlapped corresponding time-domain resources (such as a time-domain resource of a corresponding fifth PDSCH).

In some embodiments, as one candidate PDSCH reception occasion corresponds to one PDSCH, the HARQ-ACK information bits corresponding to each candidate PDSCH reception occasion are arranged in an order of the first number of candidate PDSCH reception occasions to obtain HARQ-ACK information bits of one serving cell. If a candidate PDSCH reception occasion has no corresponding second PDSCH, its corresponding HARQ-ACK information bits are set to be NACK. As described above, when the codebook includes the HARQ-ACK information bits of one serving cell, the HARQ-ACK information bits of the one serving cell are fed back as a codebook, and when the codebook includes HARQ-ACK information bits of multiple serving cells, modes for determining the HARQ-ACK information bits of each serving cell are identical to a mode for determining the HARQ-ACK information bits of previous one serving cell. However, in specific determination, other parameters such as the first time-domain resource allocation table and/or the second time-domain resource allocation table and the set of K1 to which each serving cell correspond may be identical or different. For example, the above parameters may be configured separately for each serving cell; however, this embodiment is not limited thereto. The HARQ-ACK information bits to which each serving cell correspond may be arranged in an ascending order of indices of the serving cells, so as to generate a codebook for feedback.

It should be noted that FIGS. 2 and 5 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIGS. 2 and 5.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that multiple PDSCHs may be scheduled by one piece of DCI, and feeding back HARQ-ACK information of multiple PDSCHs scheduled by one piece of DCI is supported in a new HARQ-ACK information feedback method, thereby easing the burden of monitoring the DCI of the terminal equipment, and lowering power consumption and complexity.

### Embodiment of a Second Aspect

The embodiment of this disclosure provides an information reception method, which shall be described from a side of a network device, with contents repeated with those in the embodiment of the first aspect being not going to be described herein any further.

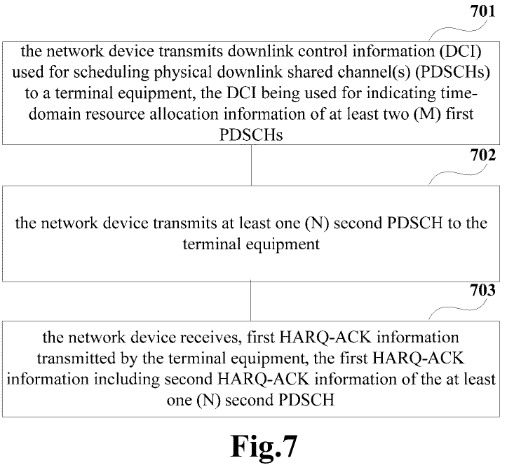

FIG. 7 is a schematic diagram of the information reception method of the embodiment of this disclosure. As shown in FIG. 7, the method includes:
701: the network device transmits downlink control information (DCI) used for scheduling physical downlink shared channel(s) (PDSCHs) to a terminal equipment, the DCI being used for indicating time-domain resource allocation information of at least two (M) first PDSCHs;
702: the network device transmits at least one (N) second PDSCH to the terminal equipment; and
703: the network device receives, first HARQ-ACK information transmitted by the terminal equipment, the first HARQ-ACK information including second HARQ-ACK information of the at least one (N) second PDSCH.

In some embodiments, implementations of 701 and 702 correspond to those of 201 and 202 in the embodiment of the first aspect, with repeated parts being not going to be described herein any further.

In some embodiments, reference may be made to the embodiment of the first aspect for contents of the DCI, the first PDSCH and a meaning of the second PDSCH, which shall not be described herein any further.

It can be seen from the above embodiment that multiple PDSCHs may be scheduled by one piece of DCI, and feeding back HARQ-ACK information of multiple PDSCHs scheduled by one piece of DCI is supported in a new HARQ-ACK information feedback method, thereby easing the burden of monitoring the DCI of the terminal equipment, and lowering power consumption and complexity.

### Embodiment of a Third Aspect

The embodiment of this disclosure provides an information feedback apparatus. The apparatus may be, for example, a terminal equipment, or may be one or more components or assemblies configured in a terminal equipment, with contents identical to those in the embodiment of the first aspect being not going to be described herein any further.

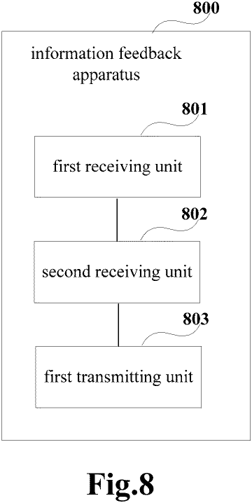

FIG. 8 is a schematic diagram of the information feedback apparatus of the embodiment of this disclosure. As shown in FIG. 8, an information feedback apparatus 800 includes:
a first receiving unit 801 configured to receive downlink control information (DCI) used for scheduling physical downlink shared channel(s) (PDSCHs), the DCI being used for indicating time-domain resource allocation information of at least two (M) first PDSCHs;
a second receiving unit 802 configured to receive at least one (N) second PDSCH; and
a first transmitting unit 803 configured to transmit first HARQ-ACK information, the first HARQ-ACK information including second HARQ-ACK information of the at least one (N) second PDSCH.

In some embodiments, reference may be made to 201-203 in the embodiment of the first aspect for implementations of the first receiving unit 801, the second receiving unit 802 and the first transmitting unit 803, with repeated parts being not going to be described herein any further.

In some embodiments, the first HARQ-ACK information is a semi-static HARQ-ACK codebook, the codebook including HARQ-ACK information bits to which a first number (A) of candidate PDSCH reception occasions correspond, the first number being a natural number.

In some embodiments, the first number (A) of candidate PDSCH reception occasions correspond to the same serving cell.

In some embodiments, the second HARQ-ACK information of the at least one (N) second PDSCH corresponds to the same candidate PDSCH reception occasion.

In some embodiments, the number of the HARQ-ACK information bits to which the candidate PDSCH reception occasion corresponds is correlated with a second number (B) to which the candidate PDSCH reception occasions correspond and/or an HARQ-ACK bundling relationship between PDSCHs.

In some embodiments, second numbers to which at least two of the first number (A) of candidate PDSCH reception occasions respectively correspond are identical or different.

In some embodiments, the second number is the number of fourth PDSCHs to which the candidate PDSCH reception occasion corresponds.

In some embodiments, numbers of feedback information bits to which at least two of the first number (A) of candidate PDSCH reception occasions respectively correspond are identical or different.

In some embodiments, the second HARQ-ACK information of the at least one (N) second PDSCH corresponds to different candidate PDSCH reception occasions.

In some embodiments, a third number (C) of candidate PDSCH reception occasions in the first number (A) of candidate PDSCH reception occasions correspond to the same downlink timing unit, and the third number is greater than 1, and/or, the third number is correlated with a ninth number (I) corresponding to the downlink timing unit and/or an HARQ-ACK bundling relationship between PDSCHs.

In some embodiments, the apparatus further includes:

a third receiving unit (optional, not shown) configured to receive configuration information used for configuring an HARQ-ACK bundling relationship between PDSCHs.

In some embodiments, the second number is a maximum number in numbers of PDSCHs to which rows determined to be satisfying a second condition in a second time-domain resource allocation table correspond;

or, the second number is a maximum number in numbers of PDSCHs to which rows determined to be satisfying a second condition in a second time-domain resource allocation table correspond other than PDSCHs which containing uplink symbols configured semi-statically, and the second time-domain resource allocation table includes configuration of at least one row of PDSCH time-domain resources.

In some embodiments, the apparatus further includes:

a first determining unit (optional, not shown) configured to determine the candidate PDSCH reception occasions according to a time-domain resource of one PDSCH in a fourth number (D) of PDSCHs to which a row in the first time-domain resource allocation table corresponds.

For example, the one PDSCH is a last PDSCH in the fourth number (D) of PDSCHs.

In some embodiments, the apparatus further includes:

a second determining unit (optional, not shown) configured to determine the candidate PDSCH reception occasions according to time-domain resources of at least two (P) PDSCHs in a fourth number (D) of PDSCHs to which a row in the first time-domain resource allocation table corresponds.

For example, P is equal to the fourth number.

In some embodiments, the HARQ-ACK information bits to which the candidate PDSCH reception occasion corresponds are arranged in an order of the fourth PDSCHs to which the candidate PDSCH reception occasion corresponds, or, the HARQ-ACK information bits to which the candidate PDSCH reception occasion corresponds are arranged in an order of the second PDSCHs to which the candidate PDSCH reception occasion corresponds, or, the HARQ-ACK information bits to which the candidate PDSCH reception occasion corresponds are arranged in an order of the first PDSCHs to which the candidate PDSCH reception occasion corresponds.

In some embodiments, the first transmitting unit 803 transmits the first HARQ-ACK information in a slot with an index n+k (slot n+k), wherein a slot with index n (slot n) is an ending slot of the at least two (M) first PDSCHs or an ending slot of a last first PDSCH in the at least two (M) first PDSCHs.

Reference may be made to the embodiment of the first aspect for a method for generating the codebook, which shall not be described herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information feedback apparatus 800 may further include other components or modules, and reference may be made to related techniques for particulars of these components or modules.

Furthermore, for the sake of simplicity, connection relationships between the components or modules or signal profiles thereof are only illustrated in FIG. 8. However, it should be understood by those skilled in the art that such related techniques as bus connection, may be adopted. And the above components or modules may be implemented by hardware, such as a processor, a memory, a transmitter, and a receiver, which are not limited in the embodiment of this disclosure.

It can be seen from the above embodiment that multiple PDSCHs may be scheduled by one piece of DCI, and feeding back HARQ-ACK information of multiple PDSCHs scheduled by one piece of DCI is supported in a new HARQ-ACK information feedback method, thereby easing the burden of monitoring the DCI of the terminal equipment, and lowering power consumption and complexity.

### Embodiment of a Fourth Aspect

The embodiment of this disclosure provides an information reception apparatus. The apparatus may be, for example, a network device, or may be one or more components or assemblies configured in a network device, with contents identical to those in the embodiment of the second aspect being not going to be described herein any further.

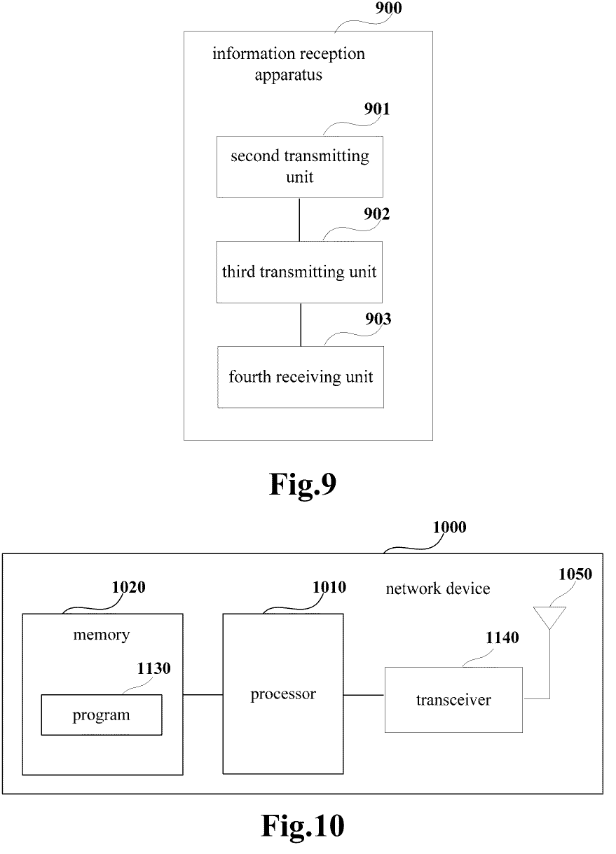

FIG. 9 is a schematic diagram of the information reception apparatus of an embodiment of this disclosure. As shown in FIG. 9, an information reception apparatus 900 includes:
a second transmitting unit 901 configured to transmit downlink control information (DCI) used for scheduling physical downlink shared channel(s) (PDSCHs) to a terminal equipment, the DCI being used for indicating time-domain resource allocation information of at least two (M) first PDSCHs;
a third transmitting unit 902 configured to transmit at least one (N) second PDSCH to the terminal equipment; and
a fourth receiving unit 903 configured to receive first HARQ-ACK information transmitted by the terminal equipment, the first HARQ-ACK information including second HARQ-ACK information of the at least one (N) second PDSCH.

In some embodiments, reference may be made to 701-703 in the embodiment of the second aspect for implementations of the second transmitting unit 901, the third transmitting unit 902 and the fourth receiving unit 903, with repeated parts being not going to be described herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information reception apparatus 900 may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection, may be adopted. And the above components or modules may be implemented by hardware, such as a processor, a memory, a transmitter, and a receiver, which are not limited in the embodiment of this disclosure.

It can be seen from the above embodiment that multiple PDSCHs may be scheduled by one piece of DCI, and feeding back HARQ-ACK information of multiple PDSCHs scheduled by one piece of DCI is supported in a new HARQ-ACK information feedback method, thereby easing the burden of monitoring the DCI of the terminal equipment, and lowering power consumption and complexity.

### Embodiment of a Fifth Aspect

The embodiment of this disclosure provides a communication system, and reference may be made to FIG. 1, with contents identical to those in the embodiments of the first to the fourth aspects being not going to be described herein any further.

In some embodiments, the communication system 100 may at least include: a terminal equipment 102 and a network device 101.

In some embodiments, the terminal equipment 102 receives downlink control information (DCI) used for scheduling physical downlink shared channel(s) (PDSCHs) transmitted by the network device 101, the DCI being used for indicating time-domain resource allocation information of at least two (M) first PDSCHs; the terminal equipment 102 receives at least one (N) second PDSCH transmitted by the network device 101; and the terminal equipment 102 transmits first HARQ-ACK information to the network device 101, the first HARQ-ACK information including second HARQ-ACK information of the at least one (N) second PDSCH.

The embodiment of this disclosure further provides a network device, which may be, for example, a base station. However, this disclosure is not limited thereto, and it may also be another network device.

FIG. 10 is a schematic diagram of the network device of the embodiment of this disclosure. As shown in FIG. 10, a network device 1000 may include a processor 1010 (such as a central processing unit (CPU)) and a memory 1020, the memory 1020 being coupled to the processor 1010. The memory 1020 may store various data, and furthermore, it may store a program 1030 for data processing, and execute the program 1030 under control of the processor 1010.

For example, the processor 1010 may be configured to execute a program to carry out the information reception method as described in the embodiment of the second aspect. For example, the processor 1010 may be configured to execute the following control: transmitting downlink control information (DCI) used for scheduling physical downlink shared channel(s) (PDSCHs) to a terminal equipment, the DCI being used for indicating time-domain resource allocation information of at least two (M) first PDSCHs; transmitting at least one (N) second PDSCH to the terminal equipment; and receiving first HARQ-ACK information transmitted by the terminal equipment, the first HARQ-ACK information including second HARQ-ACK information of the at least one (N) second PDSCH.

Furthermore, as shown in FIG. 10, the network device 1000 may include a transceiver 1040, and an antenna 1050, etc. Functions of the above components are similar to those in the related art, and shall not be described herein any further. It should be noted that the network device 1000 does not necessarily include all the parts shown in FIG. 10, and furthermore, the network device 1000 may include parts not shown in FIG. 10, and the related art may be referred to.

The embodiment of this disclosure further provides a terminal equipment; however, this disclosure is not limited thereto, and it may also be another equipment.

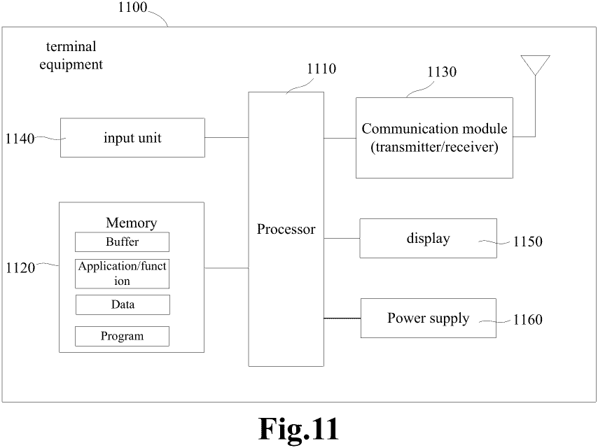

FIG. 11 is a schematic diagram of the terminal equipment of the embodiment of this disclosure. As shown in FIG. 11, a terminal equipment 1100 may include a processor 1110 and a memory 1120, the memory 1120 storing data and a program and being coupled to the processor 1110. It should be noted that this figure is illustrative only, and other types of structures may also be used, so as to supplement or replace this structure and achieve a telecommunications function or other functions.

For example, the processor 1110 may be configured to execute a program to carry out the information feedback method as described in the embodiment of the first aspect. For example, the processor 1110 may be configured to perform the following control: receiving transmitted downlink control information (DCI) used for scheduling physical downlink shared channel(s) (PDSCHs), the DCI being used for indicating time-domain resource allocation information of at least two (M) first PDSCHs; receiving at least one (N) second PDSCH; and transmitting first HARQ-ACK information, the first HARQ-ACK information including second HARQ-ACK information of the at least one (N) second PDSCH.

As shown in FIG. 11, the terminal equipment 1100 may further include a communication module 1130, an input unit 1140, a display 1150, and a power supply 1160, wherein functions of the above components are similar to those in the related art, which shall not be described herein any further. It should be noted that the terminal equipment 1100 does not necessarily include all the parts shown in FIG. 11, and the above components are not necessary. Furthermore, the terminal equipment 1100 may include parts not shown in FIG. 11, and the related art may be referred to.

An embodiment of this disclosure provides a computer readable program, which, when executed in a terminal equipment, will cause the terminal equipment to carry out the information feedback method as described in the embodiment of the first aspect.

An embodiment of this disclosure provides a computer storage medium, including a computer readable program, which will cause a terminal equipment to carry out the information feedback method as described in the embodiment of the first aspect.

An embodiment of this disclosure provides a computer readable program, which, when executed in a network device, will cause the network device to carry out the information reception method as described in the embodiment of the second aspect.

An embodiment of this disclosure provides a computer storage medium, including a computer readable program, which will cause a network device to carry out the information reception method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

1. An information feedback method, applicable to a terminal equipment, characterized in that the method includes:
receiving, by the terminal equipment, downlink control information (DCI) used for scheduling physical downlink shared channel(s) (PDSCHs), the DCI being used for indicating time-domain resource allocation information of at least two (M) first PDSCHs;
receiving at least one (N) second PDSCH by the terminal equipment;
transmitting first HARQ-ACK information by the terminal equipment, the first HARQ-ACK information including second HARQ-ACK information of the at least one (N) second PDSCH.

2. The method according to supplement 1, wherein the first HARQ-ACK information is a semi-static HARQ-ACK codebook, the codebook including HARQ-ACK information bits to which a first number (A) of candidate PDSCH reception occasions correspond, the first number being a natural number.

3. The method according to supplement 2, wherein the first number (A) of candidate PDSCH reception occasions correspond to the same serving cell.

4. The method according to supplement 2, wherein the second HARQ-ACK information of the at least one (N) second PDSCH corresponds to the same candidate PDSCH reception occasion.

5. The method according to supplement 2 or 3 or 4, wherein the number of the HARQ-ACK information bits to which the candidate PDSCH reception occasion corresponds is correlated with a second number (B) to which the candidate PDSCH reception occasion corresponds and/or an HARQ-ACK bundling relationship between PDSCHs.

6. The method according to supplement 5, wherein second numbers to which at least two of the first number (A) of candidate PDSCH reception occasions respectively correspond are identical or different.

7. The method according to supplement 2, wherein numbers of feedback information bits to which at least two of the first number (A) of candidate PDSCH reception occasions respectively correspond are identical or different.

8. The method according to any one of supplements 5-7, wherein when there exists an HARQ-ACK bundling relationship between at least two fourth PDSCHs in fourth PDSCHs to which the candidate PDSCH reception occasion corresponds, the method further includes: performing joint encoding on HARQ-ACK information bits of the at least two fourth PDSCHs between which there exists a bundling relationship.

9. The method according to supplement 5, wherein the second number is the number of fourth PDSCHs to which the candidate PDSCH reception occasion corresponds.

10. The method according to supplement 2, wherein the second HARQ-ACK information of the at least one (N) second PDSCH corresponds to different candidate PDSCH reception occasions.

11. The method according to supplement 2 or 10, wherein a third number (C) of candidate PDSCH reception occasions in the first number (A) of candidate PDSCH reception occasions correspond to the same downlink timing unit, and the third number is greater than 1, and/or, the third number is correlated with a ninth number (I) corresponding to the downlink timing unit and/or an HARQ-ACK bundling relationship between PDSCHs.

12. The method according to supplement 11, wherein when there exists an HARQ-ACK bundling relationship between the fourth PDSCHs to which the candidate PDSCH reception occasion corresponds and the downlink timing unit corresponds to the candidate PDSCH reception occasion, the third number is less than the ninth number.

13. The method according to supplement 11, wherein when there exists no HARQ-ACK bundling relationship between the fourth PDSCHs to which the candidate PDSCH reception occasion corresponds and the downlink timing unit corresponds to the candidate PDSCH reception occasion, the third number is greater than or equal to the ninth number.

14. The method according to supplement 13, wherein the third number is equal to 1 or equal to the number of rows having no overlapping on corresponding time-domain resources in a second time-domain resource allocation table, the second time-domain resource allocation table or a first time-domain resource allocation table including configuration of at least one row of PDSCH time-domain resources.

15. The method according to supplement 5 or 11, wherein the method further includes:

receiving, by the terminal equipment, configuration information used for configuring the HARQ-ACK bundling relationship between PDSCHs.

16. The method according to supplement 5 or 10, wherein the second number or the ninth number is a maximum number in numbers of PDSCHs to which rows in a second time-domain resource allocation table or a first time-domain resource allocation table correspond, and the second time-domain resource allocation table or the first time-domain resource allocation table includes configuration of at least one row of PDSCH time-domain resources.

17. The method according to supplement 5 or 10, wherein the second number or the ninth number is a maximum number in numbers of PDSCHs to which rows determined to be satisfying a second condition in a second time-domain resource allocation table correspond;

or, the second number or the ninth number is a maximum number in numbers of PDSCHs to which rows determined to be satisfying a second condition in a second time-domain resource allocation table correspond other than PDSCHs which containing uplink symbols configured semi-statically, and the second time-domain resource allocation table includes configuration of at least one row of PDSCH time-domain resources.

18. The method according to supplement 2, wherein the terminal equipment determines the candidate PDSCH reception occasions according to a time-domain resource of one PDSCH in a fourth number (D) of PDSCHs to which a row in the first time-domain resource allocation table corresponds.

19. The method according to supplement 18, wherein the one PDSCH is a last PDSCH in the fourth number (D) of PDSCHs.

20. The method according to supplement 18, wherein the fourth number (D) is greater than 1.

21. The method according to supplement 18, wherein the method further includes:
determining the second time-domain resource allocation table by the terminal equipment according to the first time-domain resource allocation table,
a row in the second time-domain resource allocation table including only configuration of time-domain resource of one PDSCH.

22. The method according to supplement 21, wherein the row in the second time-domain resource allocation table corresponds to the row in the first time-domain resource table.

23. The method according to supplement 2, wherein the terminal equipment determines the candidate PDSCH reception occasions according to time-domain resources of at least two (P) PDSCHs in the fourth number (D) of PDSCHs to which a row in the first time-domain resource allocation table corresponds.

24. The method according to supplement 23, wherein P is equal to the fourth number.

25. The method according to supplement 23, the fourth number (D) is greater than 1.

26. The method according to supplement 23, wherein the method further includes:
determining the second time-domain resource allocation table by the terminal equipment according to the first time-domain resource allocation table,
a row in the second time-domain resource allocation table including configuration of time-domain resources of the fourth number (D) of PDSCHs.

27. The method according to supplement 26, the row in the second time-domain resource allocation table corresponds to the row in the first time-domain resource table.

28. The method according to any one of supplements 2-27, wherein the HARQ-ACK information bits to which the candidate PDSCH reception occasion corresponds are arranged in an order of the fourth PDSCHs to which the candidate PDSCH reception occasion corresponds, or, the HARQ-ACK information bits to which the candidate PDSCH reception occasion corresponds are arranged in an order of the second PDSCHs to which the candidate PDSCH reception occasion corresponds, or, the HARQ-ACK information bits to which the candidate PDSCH reception occasion corresponds are arranged in an order of the first PDSCHs to which the candidate PDSCH reception occasion corresponds.

29. The method according to any one of supplement 1-28, wherein the first HARQ-ACK information is carried by a PUCCH or a PUSCH.

30. The method according to any one of supplements 1-29, wherein the second HARQ-ACK information of the at least one (N) second PDSCH is carried by the same PUCCH or PUSCH.

31. The method according to any one of supplements 1-30, wherein the terminal equipment transmits the first HARQ-ACK information in a slot with an index n+k (slot n+k), wherein a slot with index n (slot n) is an ending slot of the at least two (M) first PDSCHs or an ending slot of a last first PDSCH in the at least two (M) first PDSCHs.

32. An information reception method, applicable to a network device, characterized in that the method includes:
transmitting downlink control information (DCI) used for scheduling physical downlink shared channel(s) (PDSCHs) by the network device to a terminal equipment, the DCI being used for indicating time-domain resource allocation information of at least two (M) first PDSCHs;
transmitting at least one (N) second PDSCH by the network device to the terminal equipment; and
receiving, by the network device, first HARQ-ACK information transmitted by the terminal equipment, the first HARQ-ACK information including second HARQ-ACK information of the at least one (N) second PDSCH.

33. An information feedback apparatus, applicable to a terminal equipment, characterized in that the apparatus includes:
a first receiving unit configured to receive downlink control information (DCI) used for scheduling physical downlink shared channel(s) (PDSCHs), the DCI being used for indicating time-domain resource allocation information of at least two (M) first PDSCHs;
a second receiving unit configured to receive at least one (N) second PDSCH; and
a first transmitting unit configured to transmit first HARQ-ACK information, the first HARQ-ACK information including second HARQ-ACK information of the at least one (N) second PDSCH.

34. The apparatus according to supplement 33, wherein the first HARQ-ACK information is a semi-static HARQ-ACK codebook, the codebook including HARQ-ACK information bits to which a first number (A) of candidate PDSCH reception occasions correspond, the first number being a natural number.

35. The apparatus according to supplement 34, wherein the first number (A) of candidate PDSCH reception occasions correspond to the same serving cell.

36. The apparatus according to supplement 34, wherein the second HARQ-ACK information of the at least one (N) second PDSCH corresponds to the same candidate PDSCH reception occasion.

37. The apparatus according to supplement 34 or 35 or 36, wherein the number of the HARQ-ACK information bits to which the candidate PDSCH reception occasion corresponds is correlated with a second number (B) to which the candidate PDSCH reception occasions correspond and/or an HARQ-ACK bundling relationship between PDSCHs.

38. The apparatus according to supplement 37, wherein second numbers to which at least two of the first number (A) of candidate PDSCH reception occasions respectively correspond are identical or different.

39. The apparatus according to supplement 34, wherein numbers of feedback information bits to which at least two candidate PDSCH reception occasions in the first number (A) of candidate PDSCH reception occasions respectively correspond are identical or different.

40. The apparatus according to any one of supplements 37-39, wherein when there is an HARQ-ACK bundling relationship between at least two fourth PDSCHs in the fourth PDSCHs to which the candidate PDSCH reception occasion corresponds, the apparatus further includes: performing joint encoding on HARQ-ACK information bits of the at least two fourth PDSCHs with the bundling relationship.

41. The apparatus according to supplement 37, wherein the second number is the number of fourth PDSCHs to which the candidate PDSCH reception occasion corresponds.

42. The apparatus according to supplement 34, wherein the second HARQ-ACK information of the at least one (N) second PDSCH corresponds to different candidate PDSCH reception occasions.

43. The apparatus according to supplement 34 or 42, wherein a third number (C) of candidate PDSCH reception occasions in the first number (A) of candidate PDSCH reception occasions correspond to the same downlink timing unit, and the third number is greater than 1, and/or, the third number is correlated with a ninth number (I) corresponding to the downlink timing unit and/or an HARQ-ACK bundling relationship between PDSCHs.

44. The apparatus according to supplement 43, wherein when there exists an HARQ-ACK bundling relationship between the fourth PDSCHs to which the candidate PDSCH reception occasion corresponds and the downlink timing unit corresponds to the candidate PDSCH reception occasion, the third number is less than the ninth number.

45. The apparatus according to supplement 43, wherein when there exists no HARQ-ACK bundling relationship between the fourth PDSCHs to which the candidate PDSCH reception occasion corresponds and the downlink timing unit corresponds to the candidate PDSCH reception occasion, the third number is greater than or equal to the ninth number.

46. The apparatus according to supplement 45, wherein the third number is equal to 1 or equal to the number of rows having no overlapping on corresponding time-domain resources in a second time-domain resource allocation table, the second time-domain resource allocation table or a first time-domain resource allocation table including configuration of at least one row of PDSCH time-domain resources.

47. The apparatus according to supplement 37 or 43, wherein the apparatus further includes:

a third receiving unit configured to receive configuration information used for configuring an HARQ-ACK bundling relationship between PDSCHs.

48. The apparatus according to supplement 37 or 42, wherein the second number or the ninth number is a maximum number in numbers of PDSCHs to which rows in a second time-domain resource allocation table or a first time-domain resource allocation table correspond, and the second time-domain resource allocation table or the first time-domain resource allocation table includes configuration of at least one row of PDSCH time-domain resources.

49. The apparatus according to supplement 37 or 42, wherein the second number or the ninth number is a maximum number in numbers of PDSCHs to which rows determined to be satisfying a second condition in a second time-domain resource allocation table correspond;

or, the second number or the ninth number is a maximum number in numbers of PDSCHs to which rows determined to be satisfying a second condition in a second time-domain resource allocation table correspond other than PDSCHs which containing uplink symbols configured semi-statically, and the second time-domain resource allocation table includes configuration of at least one row of PDSCH time-domain resources.

50. The apparatus according to supplement 34, wherein the apparatus further includes:

a first determining unit configured to determine the candidate PDSCH reception occasions according to a time-domain resource of one PDSCH in a fourth number (D) of PDSCHs to which a row in the first time-domain resource allocation table corresponds.

51. The apparatus according to supplement 50, wherein the one PDSCH is a last PDSCH in the fourth number (D) of PDSCHs.

52. The apparatus according to supplement 50, wherein the fourth number (D) is greater than 1.

53. The apparatus according to supplement 50, wherein the apparatus further includes:

a third determining unit configured to determine the second time-domain resource allocation table according to the first time-domain resource allocation table, a row in the second time-domain resource allocation table including only configuration of time-domain resource of one PDSCH.

54. The apparatus according to supplement 53, wherein the row in the second time-domain resource allocation table corresponds to the row in the first time-domain resource table.

55. The apparatus according to supplement 34, wherein the apparatus further includes:

a second determining unit configured to determine the candidate PDSCH reception occasions according to time-domain resources of at least two (P) PDSCHs in the fourth number (D) of PDSCHs to which a row in the first time-domain resource allocation table corresponds.

56. The apparatus according to supplement 55, wherein P is equal to the fourth number.

57. The apparatus according to supplement 55, the fourth number (D) is greater than 1.

58. The apparatus according to supplement 55, wherein the apparatus further includes:
a fourth determining unit configured to determine the second time-domain resource allocation table according to the first time-domain resource allocation table,
a row in the second time-domain resource allocation table including configuration of time-domain resources of the fourth number (D) of PDSCHs.

59. The apparatus according to supplement 58, the row in the second time-domain resource allocation table corresponds to the row in the first time-domain resource table.

60. The apparatus according to any one of supplements 34-59, wherein the HARQ-ACK information bits to which the candidate PDSCH reception occasion corresponds are arranged in an order of the fourth PDSCHs to which the candidate PDSCH reception occasion corresponds, or, the HARQ-ACK information bits to which the candidate PDSCH reception occasion corresponds are arranged in an order of the second PDSCHs to which the candidate PDSCH reception occasion corresponds, or, the HARQ-ACK information bits to which the candidate PDSCH reception occasion corresponds are arranged in an order of the first PDSCHs to which the candidate PDSCH reception occasion corresponds.

61. The apparatus according to any one of supplement 33-60, wherein the first HARQ-ACK information is carried by a PUCCH or a PUSCH.

62. The apparatus according to any one of supplements 33-61, wherein the second HARQ-ACK information of the at least one (N) second PDSCH is carried by the same PUCCH or PUSCH.

63. The apparatus according to any one of supplements 33-62, wherein the first transmitting unit transmits the first HARQ-ACK information in a slot with an index n+k (slot n+k), wherein a slot with index n (slot n) is an ending slot of the at least two (M) first PDSCHs or an ending slot of a last first PDSCH in the at least two (M) first PDSCHs.

64. An information reception apparatus, applicable to a network device, characterized in that the apparatus includes:
a second transmitting unit configured to transmit downlink control information (DCI) used for scheduling physical downlink shared channel(s) (PDSCHs) to a terminal equipment, the DCI being used for indicating time-domain resource allocation information of at least two (M) first PDSCHs;
a third transmitting unit configured to transmit at least one (N) second PDSCH to the terminal equipment; and
a fourth receiving unit configured to receive first HARQ-ACK information transmitted by the terminal equipment, the first HARQ-ACK information including second HARQ-ACK information of the at least one (N) second PDSCH.

65. A communication system, including at least a terminal equipment and a network device, characterized in that,
the terminal equipment receives downlink control information (DCI) used for scheduling physical downlink shared channel(s) (PDSCHs) transmitted by the network device, the DCI being used for indicating time-domain resource allocation information of at least two (M) first PDSCHs;
the terminal equipment receives at least one (N) second PDSCH transmitted by the network device;
the terminal equipment transmits first HARQ-ACK information to the network device, the first HARQ-ACK information including second HARQ-ACK information of the at least one (N) second PDSCH.

What is claimed is:

1. An information feedback apparatus, applicable to a terminal equipment, the apparatus comprises:
a receiver configured to:
receive downlink control information (DCI) used for scheduling physical downlink shared channel(s) (PDSCHs), the DCI being used for indicating time-domain resource allocation information of at least two (M) first PDSCHs, and
receive at least one (N) second PDSCH; and
a transmitter configured to transmit first HARQ-ACK information, the first HARQ-ACK information comprising second HARQ-ACK information of the at least one (N) second PDSCH.

2. The apparatus according to claim 1, wherein the first HARQ-ACK information is a semi-static HARQ-ACK codebook, the codebook comprising HARQ-ACK information bits to which a first number (A) of candidate PDSCH reception occasions correspond, the first number being a natural number.

3. The apparatus according to claim 2, wherein the first number (A) of candidate PDSCH reception occasions correspond to same serving cell.

4. The apparatus according to claim 2, wherein the second HARQ-ACK information of the at least one (N) second PDSCH corresponds to same candidate PDSCH reception occasion.

5. The apparatus according to claim 2, wherein the number of the HARQ-ACK information bits to which the candidate PDSCH reception occasion corresponds is correlated with a second number (B) to which the candidate PDSCH reception occasions correspond and/or an HARQ-ACK bundling relationship between PDSCHs.

6. The apparatus according to claim 5, wherein second numbers to which at least two of the first number (A) of candidate PDSCH reception occasions respectively correspond are identical or different.

7. The apparatus according to claim 5, wherein the second number is the number of fourth PDSCHs to which the candidate PDSCH reception occasion corresponds.

8. The apparatus according to claim 2, wherein numbers of feedback information bits to which at least two of the first number (A) of candidate PDSCH reception occasions respectively correspond are identical or different.

9. The apparatus according to claim 2, wherein the second HARQ-ACK information of the at least one (N) second PDSCH corresponds to different candidate PDSCH reception occasions.

10. The apparatus according to claim 2, wherein a third number (C) of candidate PDSCH reception occasions in the first number (A) of candidate PDSCH reception occasions correspond to same downlink timing unit, and the third number is greater than 1, and/or, the third number is correlated with a ninth number (I) corresponding to the downlink timing unit and/or an HARQ-ACK bundling relationship between PDSCHs.

11. The apparatus according to claim 1, wherein the receiver configured to receive configuration information used for configuring an HARQ-ACK bundling relationship between PDSCHs.

12. The apparatus according to claim 5, wherein the second number is a maximum number in numbers of PDSCHs to which rows determined to be satisfying a second condition in a second time-domain resource allocation table correspond;
or, the second number is a maximum number in numbers of PDSCHs to which rows determined to be satisfying a second condition in a second time-domain resource allocation table correspond other than PDSCHs which containing uplink symbols configured semi-statically, and the second time-domain resource allocation table includes configuration of at least one row of PDSCH time-domain resources.

13. The apparatus according to claim 2, wherein the apparatus further comprises:
a controller configured to determine the candidate PDSCH reception occasions according to a time-domain resource of one PDSCH in a fourth number (D) of PDSCHs to which a row in the first time-domain resource allocation table corresponds.

14. The apparatus according to claim 13, wherein the one PDSCH is a last PDSCH in the fourth number (D) of PDSCHs.

15. The apparatus according to claim 2, wherein the apparatus further comprises:
a controller configured to determine the candidate PDSCH reception occasions according to time-domain resources of at least two (P) PDSCHs in a fourth number (D) of PDSCHs to which a row in the first time-domain resource allocation table corresponds.

16. The apparatus according to claim 15, wherein P is equal to the fourth number.

17. The apparatus according to claim 2, wherein the HARQ-ACK information bits to which the candidate PDSCH reception occasion corresponds are arranged in an order of the fourth PDSCHs to which the candidate PDSCH reception occasion corresponds, or, the HARQ-ACK information bits to which the candidate PDSCH reception occasion corresponds are arranged in an order of the second PDSCHs to which the candidate PDSCH reception occasion corresponds, or, the HARQ-ACK information bits to which the candidate PDSCH reception occasion corresponds are arranged in an order of the first PDSCHs to which the candidate PDSCH reception occasion corresponds.

18. The apparatus according to claim 1, wherein the transmitter transmits the first HARQ-ACK information in a slot with an index n+k (slot n+k), wherein a slot with index n (slot n) is an ending slot of the at least two (M) first PDSCHs or an ending slot of a last first PDSCH in the at least two (M) first PDSCHs.

19. An information reception apparatus, applicable to a network device, the apparatus comprises:
a transmitter configured to:
transmit downlink control information (DCI) used for scheduling physical downlink shared channel(s) (PDSCHs) to a terminal equipment, the DCI being used for indicating time-domain resource allocation information of at least two (M) first PDSCHs, and transmit at least one (N) second PDSCH to the terminal equipment; and
a receiver configured to receive first HARQ-ACK information transmitted by the terminal equipment, the first HARQ-ACK information comprising second HARQ-ACK information of the at least one (N) second PDSCH.

20. A communication system, comprising at least a terminal equipment and a network device, characterized in that,
the terminal equipment receives downlink control information (DCI) used for scheduling physical downlink shared channel(s) (PDSCHs) transmitted by the network device, the DCI being used for indicating time-domain resource allocation information of at least two (M) first PDSCHs;
the terminal equipment receives at least one (N) second PDSCH transmitted by the network device;
the terminal equipment transmits first HARQ-ACK information to the network device, the first HARQ-ACK information comprising second HARQ-ACK information of the at least one (N) second PDSCH.
